(19) United States
(12) Patent Application Publication
(10) Pub. No.: US 2013/0232423 A1
(43) Pub. Date: Sep. 5, 2013

(54) DISPLAY APPARATUS AND OPERATION CHECKING METHOD FOR THE DISPLAY APPARATUS

(71) Applicant: Junichi Hamanaka, Tokyo (JP)

(72) Inventor: Junichi Hamanaka, Tokyo (JP)

(73) Assignee: MITSUBISHI ELECTRIC CORPORATION, Tokyo (JP)

(21) Appl. No.: 13/884,465

(22) PCT Filed: Feb. 3, 2011
(86) PCT No.: PCT/JP2011/052284

§ 371 Date: May 9, 2013

(51) Int. Cl. G06F 3/0484

(52) U.S. Cl. CPC G06F 3/0484
USPC 715/736

(57) ABSTRACT

A display apparatus includes a display unit configured to display, about an external apparatus set as a control target by a controller, apparatus information concerning an operation state on a screen, a display-setting-information displaying unit configured to cause the display unit to display, on the screen, display setting information specified by retrieval in a display-setting-information retrieving unit, a device-value requesting unit configured to request the controller to transmit a device value retained by a device, which is an area in a memory that stores the apparatus information in the controller, a device-value receiving unit configured to receive the device value transmitted by the controller in response to the request by the device-value requesting unit, and a device-value displaying unit configured to cause the device value received by the device-value receiving unit to be displayed on the screen.

### FIELD

The present invention relates to a display apparatus in a system for automatically controlling, with a controller, a robot, a numerical control apparatus, and the like and an operation checking method for the display apparatus.

### BACKGROUND

In a system for automatically controlling, with a controller, a robot, a numerical control apparatus, a machine tool, and the like set in a production line, a display apparatus including a touch panel-equipped liquid crystal display is provided. The display apparatus displays, with a display unit such as a liquid crystal display, operation states (apparatus information) of these external apparatuses controlled by the controller. The display apparatus receives, in an input unit such as a touch panel, an operation input for giving a control instruction to the controller. A user can uniquely create a screen displayed on the display unit using a screen data creating apparatus to match a system for performing control.

The user creates a screen using, as components, images representing a switch, a meter, a graph, and the like provided by the screen data creating apparatus. The user associates devices, which are areas in a memory of the controller, with these components. The user performs setting of conditions for changing display of components and device values according to the system for performing control and designation of a processing method for the devices for making it easy to recognize a state of the system for performing control.

The display apparatus receives apparatus information of a system that operates according to a program written in the controller. The display apparatus performs display according to the apparatus information. In the display apparatus, display setting information created in advance for the display of the apparatus information is set.

In the system of the production line, in some case, the user desires to check contents of display setting information stored in the display apparatus. In the related art, as a method of checking the display setting information, for example, there is a method of connecting the screen data creating apparatus to the display apparatus and reading out the display setting information using the screen data creating apparatus. Like the technologies proposed in Patent Literatures 1 and 2, there is a method of switching a display mode of a screen of the display apparatus from a mode for displaying the operation states to a mode for displaying the display setting information.

### CITATION LIST

### Patent Literature

Patent Literature 1: Japanese Patent Application Laid-open No. 11-45110
Patent Literature 2: Japanese Patent Application Laid-open No. 2006-285496

### SUMMARY

### Technical Problem

In the method of connecting the screen data creating apparatus to the display apparatus, there is a problem in that, because of concern about security, it is difficult to enable the screen data creating apparatus to be carried into the production line. There is also a problem in that, when the display mode is simply switched to display the display setting information, it is often insufficient for the user to grasp which of problems such as an error in the display setting information and a deficiency of the system occurs.

The present invention has been devised in view of the above and it is an object of the present invention to obtain a display apparatus that enables a user to easily and quickly grasp problems such as an error in display setting information and a deficiency of a system and an operation checking method for the display apparatus.

### Solution to Problem

To solve the above problem and attain the above object, a display apparatus according to the present invention includes: a display unit configured to display, about an external apparatus set as a control target by a controller, apparatus information concerning an operation state on a screen; a storing unit configured to store display setting information set for the display of the apparatus information on the display unit; a display-mode switching unit configured to switch the screen to a normal display mode for displaying the apparatus information and a display setting information display mode for displaying the display setting information; a display-setting-information retrieving unit configured to retrieve the display setting information from the storing unit; a display-setting-information displaying unit configured to cause the display setting information specified by the retrieval in the display-setting-information retrieving unit to be displayed on the screen, in the display setting information display mode; a device-value requesting unit configured to request the controller to transmit a device value retained by a device, which is an area in a memory that stores the apparatus information in the controller; a device-value receiving unit configured to receive the device value transmitted by the controller in response to the request by the device-value requesting unit; and a device-value displaying unit configured to cause the device value received by the device-value receiving unit to be displayed on the screen. The device-value requesting unit receives input operation performed according to content of the display setting information displayed by the display-setting-information displaying unit and requests transmission of the device value.

### Advantageous Effects of Invention

The display apparatus according to the present invention displays the display setting information specified by the retrieval and also the device value specified by the display setting information. Therefore, the display apparatus realizes an effect that it is possible to easily and quickly grasp problems such as an error in the display setting information and a deficiency of the system.

### BRIEF DESCRIPTION OF DRAWINGS

FIG. 1 is a block diagram of the configurations of a display apparatus and a controller according to a first embodiment.

FIG. 2 is a diagram of an example of a format database stored in a nonvolatile memory.

FIG. 3 is a diagram of an example of specified contents of values stored in respective items of the format database shown in FIG. 2.

FIG. 4 is a diagram of an example of a module configuration of a system program in the display apparatus according to the first embodiment.

FIG. 5 is a flowchart for explaining a detailed processing procedure by a format retrieving module.

FIG. 6 is a diagram of an example of a format database corresponding to display setting information (A), (B), and (C).

FIG. 7 is a diagram of a display example of display setting contents in the display setting information (B) and a device value of a word device #2.

FIG. 8 is a diagram of an example of a module configuration of a system program in a display apparatus according to a second embodiment.

FIG. 9 is a flowchart for explaining a detailed processing procedure by a changed content displaying module.

FIG. 10 is a diagram of a display example of display setting contents in the display setting information (C) and condition device values of a bit device #3.

FIG. 11 is a diagram of an example of a device character string database stored in a nonvolatile memory.

FIG. 12 is a diagram of an example of specified contents of values stored in respective items of the device character string database shown in FIG. 11.

FIG. 13 is a diagram of an example of a module configuration of a system program in a display apparatus according to a third embodiment.

FIG. 14 is a flowchart for explaining a detailed processing procedure by a device character string displaying module.

FIG. 15 is a diagram of an example of a device character string database corresponding to display setting information (A), (B), (C).

FIG. 16 is a diagram of a display example of display setting contents in the display setting information (C) and condition device values of a bit device #3.

FIG. 17 is a diagram of a configuration example of a system of a production line controlled by a controller.

FIG. 18 is a block diagram of a hardware configuration of a monitor system for setting display setting information.

FIG. 19 is a diagram of an example of allocation of apparatus information and devices.

FIG. 20 is a diagram of an example of display setting information stored in a nonvolatile memory.

FIG. 21 is a diagram of an example of specified contents of values stored in respective items of the display setting information shown in FIG. 20.

FIG. 22 is a diagram of areas partitioned in a rectangular shape on a display unit and numerical values affixed to the respective areas.

FIG. 23 is a diagram of specified contents of three kinds of display setting information (A), (B), and (C) stored in a nonvolatile memory of the display apparatus.

FIG. 24 is a diagram of a display example of display setting contents by the display setting information (B).

FIG. 25 is a diagram of a display example of the display setting contents.

FIG. 26 is a diagram of a display example of display setting contents by the display setting information (C).

### DESCRIPTION OF EMBODIMENTS

Embodiments of a display apparatus and an operation checking method for the display apparatus according to the present invention are explained in detail below based on the drawings. The present invention is not limited by the embodiments.

First, with reference to, as an example, a system of a production line controlled by a controller as shown in FIG. 17, a related art of a display apparatus used in a system of the production line is explained. A display apparatus 75 is connected to a controller 3. A conveyor 52 is one of external apparatuses set as control targets by the controller 3. In the system of the production line, a user operates a touch panel mounted on the display apparatus 75 to thereby switch the operation of the conveyor 52. A workpiece 53 on the conveyor 52 moves according to the operation of the conveyor 52.

A sensor 51 set in the conveyor 52 detects passage of the workpiece 53. When detecting the workpiece 53, the sensor 51 outputs a signal to the controller 3. A safety door 50 set in the conveyor 52 outputs an opening and closing signal indicating an opening and closing state to the controller 3. Two programs, i.e., a program for outputting a signal to the conveyor 52 according to an input from the display apparatus 75 and a program for counting inputs from the sensor 51 are written in the controller 3.

The display apparatus 75 receives apparatus information of a system of a production line that operates according to the programs written in the controller 3. The display apparatus 75 performs display based on display setting information for displaying a state of the apparatus. The display setting information is created in advance to correspond to the apparatus information. The display apparatus 75 receives the opening and closing signal input to the controller 3 from the safety door 50. The display setting information is set such that a change request for the apparatus information is transmitted from the display apparatus 75 to the controller 3 according to operation by the user only when the safety door 50 is closed. Correspondence between devices, which are areas in the memory of the controller 3, and apparatus information is described in system specifications 2.

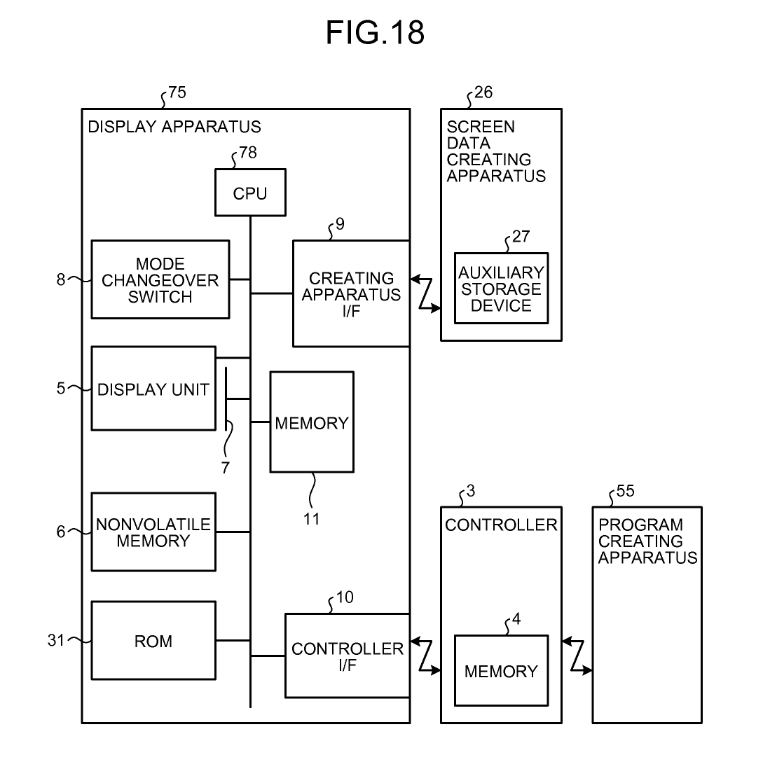

The display setting information is set by a screen data creating apparatus connected to the display apparatus 75. FIG. 18 is a block diagram of a hardware configuration of a monitor system for setting the display setting information. The monitor system includes the display apparatus 75, the controller 3, and a screen data creating apparatus 26.

The controller 3 includes a memory 4 for storing apparatus information of an external apparatus. A storage area of the memory 4 is partitioned into a plurality of areas referred to as devices. Codes affixed to specify the respective devices are referred to as device codes. The user allocates one or more devices to one kind of apparatus information as storage areas for the apparatus information.

As the devices, for example, there are a bit device and a word device. The bit device stores, as device values, bits representing two kinds of states of “0” or “1”. The word device stores, as device values, words representing numbers. In the following explanation, information representing whether a device value stored by a device is a bit or a word is referred to as device type.

In the example of the system of the production line shown in FIG. 17, an output state of a signal from a controller 3 to the conveyor 52 only has to be capable of representing two states, i.e., presence or absence of an output. Therefore, such information is stored in the bit device. An opening and closing signal from the safety door 50 to the controller 3 only has to be capable of representing two states, i.e., open and close of the safety door 50. Therefore, the opening and closing signal is stored in the bit device.

A value obtained by counting inputs from the sensor 51 in the controller 3 is stored in the word device. In the following explanation, a plurality of bit devices in the memory 4 provided in the controller 3 are referred to as bit devices #1, #2, . . . and a plurality of word devices in the memory 4 are referred to as word devices #1, #2, . . . as appropriate. #1, #2, . . . are device codes. The controller 3 is capable of performing more complicated control by allocating the devices in the memory 4 to a plurality of kinds of apparatus information.

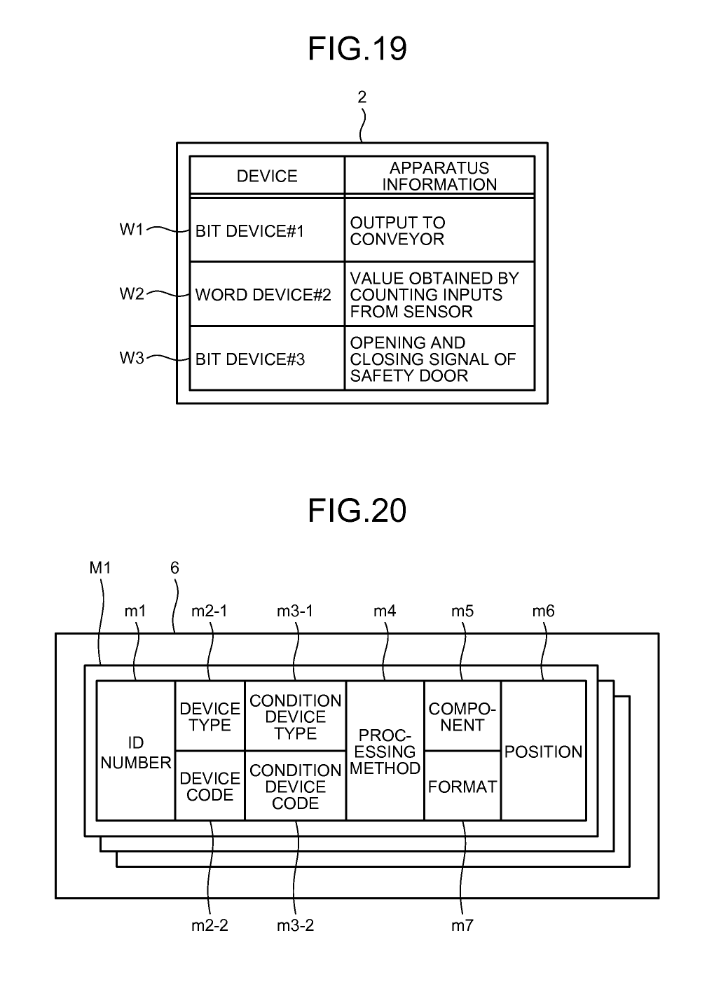

FIG. 19 is a diagram of an example of the apparatus information and the devices. A table showing the allocation of the apparatus information and the devices is described in the system specification 2. In this example, allocation W1 indicates that an output signal to the conveyor 2 is allocated to the bit device #1. Allocation W2 indicates that a value obtained by counting inputs from the sensor 51 is allocated to the word device #2. Allocation W3 indicates that an opening and closing signal of the safety door 50 is allocated to the bit device #3.

A program creating apparatus 55 creates a program of the controller 3. The program creating apparatus 55 is connected to the controller 3. The program created by the program creating apparatus 55 is transferred to the controller 3. As the program creating apparatus 55, a computing apparatus such as a personal computer is used. The program creating apparatus 55 includes a display unit (not shown in the figure) configured to display, for example, a list of device values of the controller 3.

When the devices are used in the program created by the program creating apparatus 55, to allow the user to easily recognize the device codes, in some case, a character string is allocated to the device codes on the program creating apparatus 55. For example, if the devices are the bit devices, a character string BIT1, 2, . . . is used and, if the devices are the word devices, a character string WORD1, 2, . . . is used instead of the device codes.

The screen data creating apparatus 26 is an apparatus that performs creation of screen data including display setting information for displaying apparatus information of an external apparatus in the display apparatus 75 and display setting information output from the display apparatus 75 to the external apparatus via the controller 3. As the screen data creating apparatus 26, a computing apparatus such as a personal computer is used. The screen data creating apparatus 26 includes an auxiliary storage device 27 for storing the created screen data. The screen data is data set by the user. The screen data includes, for example, display setting information created by the user, the luminance of a screen, and the volume of a buzzer.

The display apparatus 75 includes a display unit 5, a mode changeover switch 8, a nonvolatile memory 6, a screen data creating apparatus interface (hereinafter referred to as creating apparatus I/F) 9, a controller interface (hereinafter referred to as controller I/F) 10, a memory 11, a CPU 78, and a ROM 31.

The display unit 5 displays, about the conveyor 52, which is an external apparatus set as a control target by the controller 3, apparatus information concerning an operation state on a screen. The display unit 5 is, for example, a liquid crystal display. A touch panel 7 is input means for receiving input operation by the user and is attached to the surface of the display unit 5. The nonvolatile memory 6 is, for example, a flash memory. The nonvolatile memory 6 stores screen data including display setting information.

The creating apparatus I/F 9 performs transmission and reception of data between the creating apparatus I/F 9 and the screen data creating apparatus 26. The controller I/F 10 performs transmission and reception of data between the controller I/F 10 and the controller 3. The ROM 31 stores a system program. The CPU 78 controls the entire system based on the system program stored in the ROM 31. The memory 11 functions as a work memory necessary when the CPU 28 executes the system program stored in the ROM 31. The memory 11 includes a data area, a device type area, and a device code area (all of which are not shown in the figure).

The mode changeover switch 8 switches the screen of the display unit 5 to a display mode for displaying apparatus information of an external apparatus and a display mode for displaying display setting information. The system program stored in the ROM 31 can define, as the switching of the modes, specific operation set in advance through the touch panel 7 and a specific input set in advance from the controller 3. In this case, in the display apparatus 75, the mode changeover switch 8 can be omitted.

Apparatus information displayed by the display apparatus 75 is received from the controller 3. The controller 3 is indispensable in a monitor system and can be regarded as a part of the display apparatus 75.

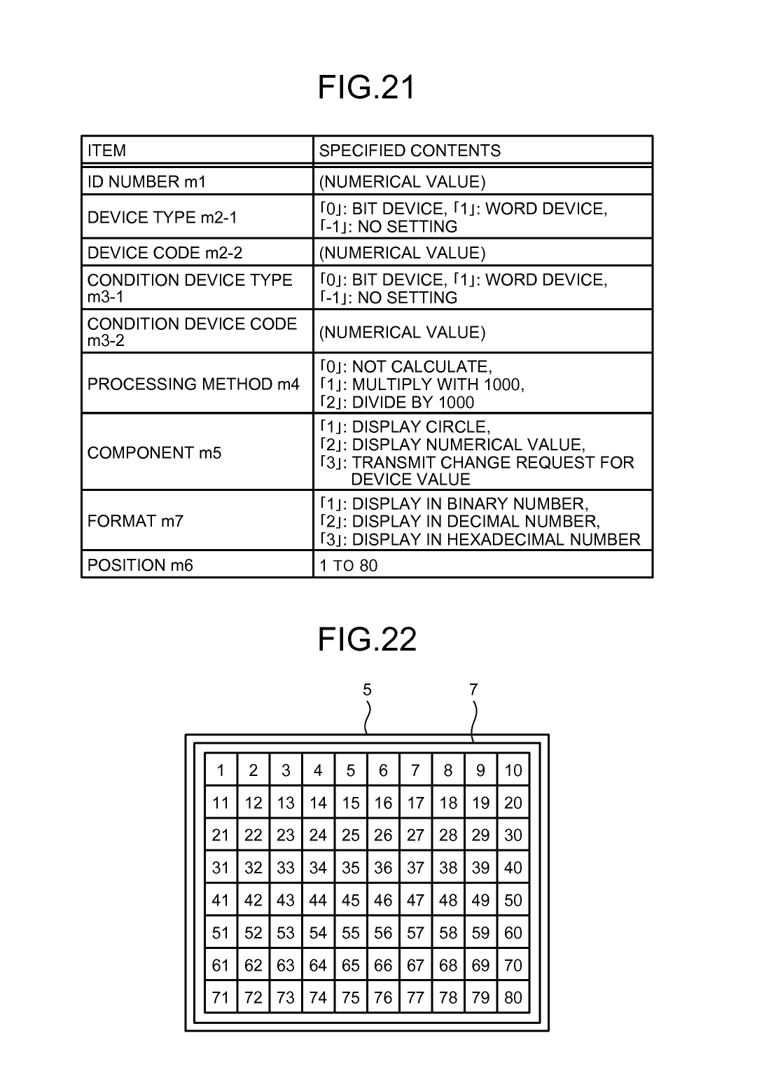

FIG. 20 is a diagram of an example of display setting information stored in the nonvolatile memory. FIG. 21 is a diagram of an example of specified contents of values stored in respective items of the display setting information shown in FIG. 20. The user creates display setting information M1 in the screen data creating apparatus 26. Areas for storing the display setting information M1 in the nonvolatile memory 6 include areas for storing an ID number m1, a device type m2-1, a device code m2-2, a condition device type m3-1, a condition device code m3-2, a processing method m4, a component m5, a format m7, and a position m6. The display setting information M1 is present as many as the number of kinds of information created by the user.

The ID number m1 is a number for specifying arbitrary display setting information and is represented by a numerical value. The item of the device type m2-1 indicates whether a device is set as display setting information and indicates, when a device is set, whether the device is a bit device or a word device.

The item of the condition device type m3-1 indicates whether a condition device, which is a device in which conditions are stored, is set as display setting information and indicates, when a condition device is set, whether the condition device is a bit device or a word device. In this example, as specified contents of the device type m2-1 and the condition device type m3-1, “0” represents a bit device, “1” represents a word device, and “−1” represents no setting.

The device code m2-2 is a code affixed to each of a plurality of devices present in the memory 4 of the controller 3 and is represented by a numerical value. The condition device code m3-2 is a code affixed to each of a plurality of condition devices present in the memory 4 of the controller 3 and is represented by a numerical value.

The item of the processing method m4 indicates a calculation method in displaying a device value received from the controller 3 on the display unit 5 and a calculation method in transmitting a value input to the touch panel 7 to the controller 3 as a change request for the device value. In this example, as specified contents of the processing method m4, “0” represents that a value is not calculated, “1” represents that a value is multiplied by 1000, and “2” represents that a value is divided by 1000.

The item of the component m5 defines whether a change request for a device value is transmitted to the controller, which of a figure and a numerical value is displayed on the display unit 5, and the shape of the figure when the figure is displayed. In this example, as specified contents of the component m5, “1” represents display of a circle, “2” represents display of a numerical value, and “3” represents that a request for changing the device value to “1” or a value processed by the method specified by the processing method m4 is transmitted to the controller 3.

When the condition device type m3-1 is “0” indicating a bit device, only when a condition device value is “1”, display designated by the item of the component m5 is performed on the display unit 5 or a change request for a device value is transmitted from the controller I/F 10. When the condition device type m3-1 is “1” indicating a word device, only when the condition device value is a designated value, display designated by the item of the component m5 is performed on the display unit 5 or the change request for a device value is transmitted from the controller I/F 10. In FIG. 21, a data area for storing the condition device value is not shown.

The item of the position m6 indicates in which position of the display unit 5 display of the component m5 is performed. Positions on the display unit 5 are represented by, for example, numerical values 1 to 80 affixed to respective areas partitioned in a rectangular shape as shown in FIG. 22. Because the touch panel 7 is laid over the display unit 5, the numerical values shown in FIG. 22 represent positions on the touch panel 7 as well.

The item of the format m7 defines a display form of a device value on the display unit 5. In this example, as specified contents of the format m7, “1” represents display in a binary number, “2” represents display in a decimal number, and “3” represents display in a hexadecimal number. In the item of the format m7, a color to be displayed on the display unit 5, the number of digits to be displayed, and the like can be displayed.

It is assumed that, in the system of the production line shown in FIG. 17, to display apparatus information obtained from the controller 3 on the display apparatus 75, display setting information (A) and (B) explained below is set in the screen data creating apparatus 26. It is assumed that, to transmit the apparatus information from the display apparatus 75 to the controller 3, display setting information (C) explained below is set in the screen data creating apparatus 26.

(A) A state of an output of a signal from the controller 3 to the conveyor 52 is allocated to the bit device #1 (allocation W1). A device value of the bit device #1 at the time when the conveyor 52 is operating is represented as “1” and a device value of the bit device #1 at the time when the conveyor 52 is stopped is represented as “0”. The display unit 5 displays a circle to correspond to the device value “1” of the bit device #1. The display unit 5 displays nothing with respect to the device value “0” of the bit device #1.

(B) A value obtained by counting inputs from the sensor 51 is allocated to the word device #2 (allocation W2). The display unit 5 displays a numerical value obtained by dividing a production volume of the workpiece 53, which is a counted value, by 1000.

(C) An opening and closing signal of the safety door 50 is allocated to the bit device #3 (allocation W3). A device value of the bit device #3 at the time when the safety door 50 is closed is represented as “1” and a device value of the bit device #3 at the time when the safety door 50 is open is represented as “0”. When the device value of the bit device #3 is “1”, the controller I/F 10 transmits, according to a touch input to the touch panel 7, a request for changing the device value of the bit device to “1” to the controller 3.

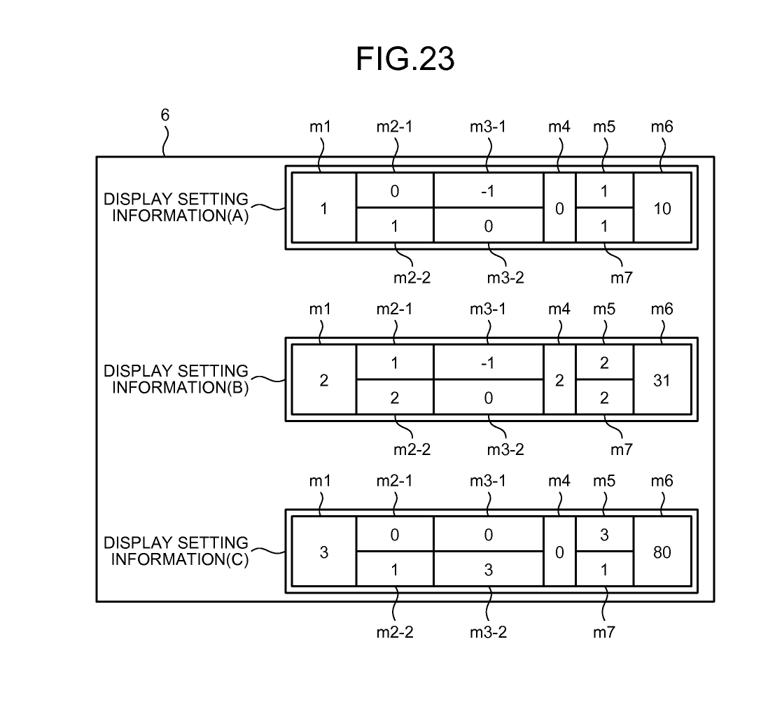

FIG. 23 is a diagram of specified contents of three kinds of display setting information (A), (B), and (C) stored in the nonvolatile memory of the display apparatus. The screen data creating apparatus 26 creates the three kinds of display setting information (A), (B), and (C) corresponding to the respective specified contents.

In the system of the production line shown in FIG. 17, in some case, the user desires to check contents of display setting information stored in the nonvolatile memory 6 of the display apparatus 75. The user desires to check the contents, for example, when, although the conveyor 52 is operating, the circle designated by the display setting information (A) is not displayed, when the numerical value designated by the display setting information (B) does not change even if the workpiece 3 passes the sensor 51, or when the conveyor 52 does not operate even if the user touches the position on the touch panel 7 designated by the display setting information (C).

As a first method of checking the display setting information stored in the nonvolatile memory 6, for example, there is a method of connecting the screen data creating apparatus 26 to the display apparatus 75 and using the screen data creating apparatus 26. The screen data creating apparatus 26 reads out the display setting information stored in the nonvolatile memory 6 to the auxiliary storage device 27 of the screen data creating apparatus 26 through the creating apparatus I/F 9 of the display apparatus 75.

In the case of the first method of checking the display setting information, the user always carries the screen data creating apparatus 26. The screen data creating apparatus 26 is connected to the display apparatus 75 to thereby enable anybody to acquire the display setting information from the nonvolatile memory 6. Therefore, when the screen data creating apparatus 26 is always carried, there is a problem of a concern about security. Therefore, it is difficult to allow the user to carry the screen data creating apparatus 26 into the production line. An inconvenience occurs in that a procedure for obtaining permission for carrying in the screen data creating apparatus 26 takes time.

As a second method of checking the display setting information, there is a method of switching the display mode of the screen of the display apparatus 75 from the mode for displaying an operation state to the mode for displaying the display setting information in the same manner as the technologies disclosed in Patent Literatures 1 and 2.

In the second method, for example, when the user notices that the numerical value designated by the display setting information (B) does not change even if the workpiece 53 passes the sensor 51, the user operates the mode changeover switch 8. Subsequently, the user touches, on the touch panel 7, the position designated by the display setting information (B) to select the display setting information (B). The CPU 78 of the display apparatus 75 detects a state of the mode changeover switch 8, retrieves, from the nonvolatile memory 6, display setting information in which the position m6 matching the touched position on the touch panel 7 is set, and acquires the display setting information (B).

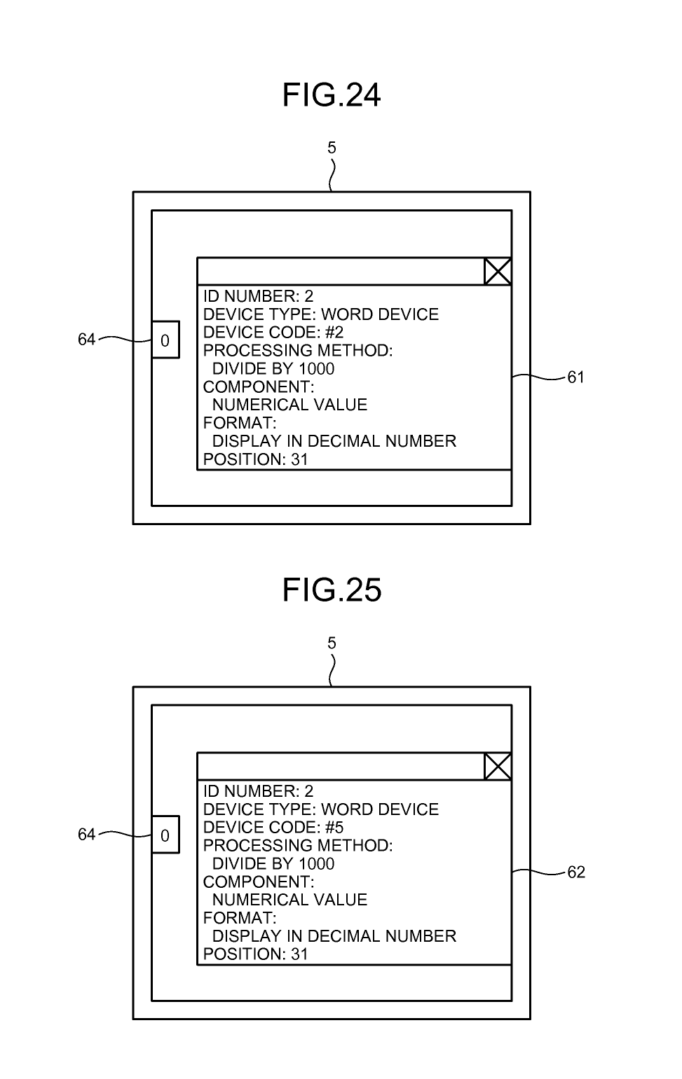

When the CPU 78 reads out the display setting information (B), the display unit 5 displays display setting contents 61 by the display setting information (B), for example, as shown in FIG. 24. In the display setting contents 61, “2” is displayed as the ID number m1, wording “word device” is displayed as the device type m2-1, “#2” is displayed as the device code m2-2, wording “divide by 1000” is displayed as the processing method m4, wording “numerical value” is displayed as the component m5, wording “display in a decimal number” is displayed as the format m7, and “31” is displayed as the position m6. A position 64 on the display unit 5 represents the position m6 set in the display setting information (B).

It is assumed that the display unit 5 displays, for example, display setting contents 62 shown in FIG. 25. In the display setting contents 62, “2” is displayed as the ID number m1, wording “word device” is displayed as the device type m2-1, “#5” is displayed as the device code m2-2, wording “divide by 1000” is displayed as the processing method m4, “numerical value” is displayed as the component m5, wording “display in a decimal number” is displayed as the format m7, and “31” is displayed as the position m6.

The user compares the display setting contents 62 with the description of the system specifications 2. According to the display setting contents 62, the device type m2-1 is “word device” and the device code m2-2 is “#5”. This indicates that “word device #5” is set in the display setting information (B). On the other hand, in the allocation W2 of the system specifications 2 shown in FIG. 19, “word device #2” is described. The user can notice an error in the display setting information (B) by comparing the display setting contents 62 and the description of the system specifications 2.

In the second method, for example, it is assumed that the user operates the mode changeover switch 8, touches, on the touch panel 7, the position designated by the display setting information (C), and selects the display setting information (C). The CPU 78 of the display apparatus 75 reads a state of the mode changeover switch 8, retrieves, from the nonvolatile memory 6, display setting information in which the position m6 matching the touched position on the touch panel 7 is set, and acquires the display setting information (C).

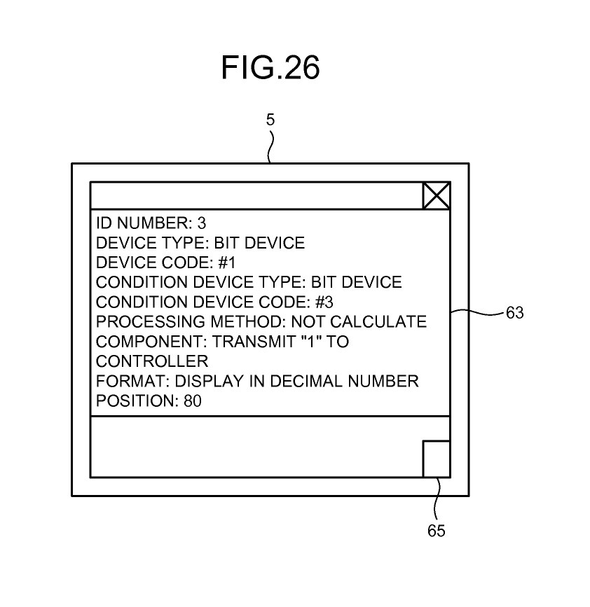

When the CPU 78 reads out the display setting information (C), the display unit 5 displays the display setting contents 63 by the display setting information (C), for example, as shown in FIG. 26. In the display setting contents 63, “3” is displayed as the ID number m1, wording “bit device” is displayed as the device type m2-1, “#1” is displayed as the device code m2-2, wording “bit device” is displayed as the condition device type m3-1, “#3” is displayed as the condition device code, wording “not calculate” is displayed as the processing method m4, wording “transmit “1” to the controller” is displayed as the component m5, wording “display in a decimal number” is displayed as the format m7, and “80” is displayed as the position m6. A position 65 on the display unit 5 represents the position m6 set in the display setting information (C). The user compares the display setting contents 63 with the description of the system specification 2 and verifies presence or absence of an error in the display setting information (C).

In the case of the second method of checking the display setting information, it is likely that an error in the display setting information or a deficiency of the monitor system including the display apparatus 75 is overlooked because of reasons explained below. For example, in the display setting contents 64 shown in FIG. 24, the word “divide by 1000” is displayed as the processing method m4. Therefore, when a device value of the word device #2 is smaller than 1000, “0” is displayed in the position 64 of the display unit 5.

When a value obtained by counting inputs from the sensor 51 and dividing the count by 1000 in the controller 3 is already stored in the word device #2, to correctly display a value obtained by dividing a production volume by 1000, it is necessary to set “0” in the processing method m4 to indicate that a value is not calculated. When a value obtained by counting inputs from the sensor 51 is smaller than 1000, the display of the position 64 becomes “0” both when “0” is correctly set in the processing method m4 and when “2” (divided by 1000) is set in the processing method m4 by mistake. In this way, it is likely that the user overlooks an error in the processing method m4.

Further, when communication between the controller I/F 10 and the controller 3 is interrupted because of some cause, the display of the position 64 on the display unit 5 cannot be updated. When the display of the position 64 does not change from “0”, there is also a problem in that the user cannot determine whether the display apparatus 75 has received a device value from the controller 3.

In addition to the second method, the program creating apparatus 55 is connected to the controller 3 and the list of device values of the controller 3 is monitored, whereby it is possible to confirm that a value obtained by counting inputs from the sensor 51 is not stored in the word device #2. In this case, as in the case of the use of the screen data creating apparatus 26, it is difficult to carry the program creating apparatus 55 into the production line because of a concern about security. Even if the program creating apparatus 55 is used, there is still the problem in that the user cannot determine whether the display apparatus 75 has received a device value from the controller 3.

For example, when the connection between the safety door 50 and the controller 3 is interrupted because of some cause, the controller 3 cannot acquire an opening and closing signal from the safety door 50 and a device value of the bit device #3 of the controller 3 is always “0”. The display apparatus 75 acquires “0” as the device value of the bit device #3. Even if the user touches, on the touch panel 7, the position m6 set in the display setting information (C), values of the bit device #3 set in the condition device type m3-1 and the condition device code m3-2 do not change to “1”.

Therefore, a request for changing a device value of the bit device #1 to “1” is not transmitted from the controller 3 and the conveyor 52 does not operate. There is no difference between the display setting contents 63 and the allocation W3 described in the system specifications 2. Therefore, the user cannot notice a cause of the non-operation of the conveyor 52.

In this case, the program creating apparatus 55 is connected to the controller 3 and the list of device values of the controller 3 is monitored, whereby the user can confirm that the device value of the bit device #3 does not change according to opening and closing of the safety door 50. In this case as well, there is an inconvenience that it is difficult to carry the program creating apparatus 55 into the production line.

In this way, when the display setting information is simply displayed, it is insufficient for the user to notice an error in the display setting information and a deficiency of the system including the display apparatus. The inventor has found that means for enabling the user to easily refer to a device value specified by the display setting information is useful in investigating a cause of a deficiency of the system including the display apparatus.

### First Embodiment

In the present invention, a device value obtained by using a device type and a device code of display setting information is used for displaying a component designated by the display setting information. Moreover, the device value itself is displayed together with the display setting information. To assist a user in understanding a displayed device value, a format database is prepared to make it possible to display the device value in an appropriate representation form. Concerning components denoted by reference numerals and signs same as the above, redundant explanation is omitted as appropriate.

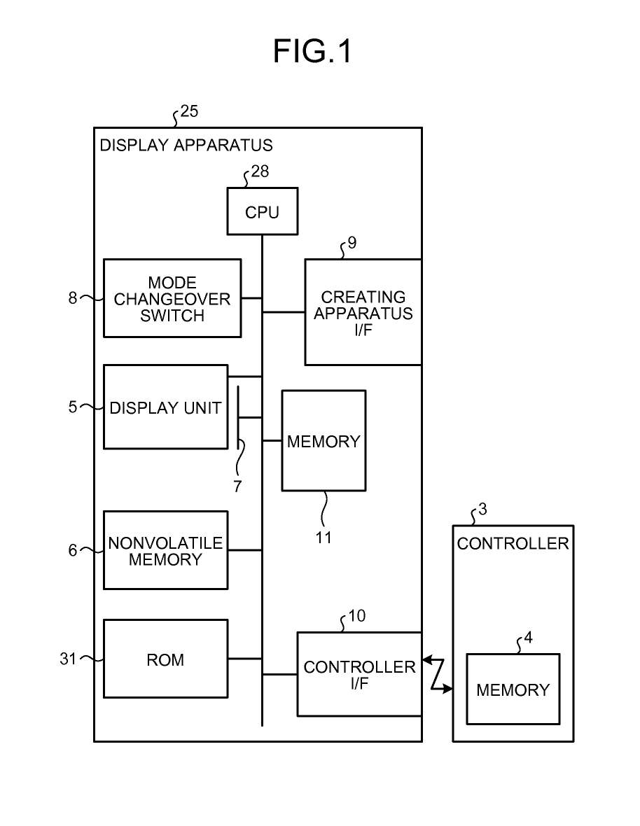

FIG. 1 is a block diagram of the configurations of a display apparatus and a controller according to the first embodiment. A display apparatus 25 includes the display unit 5, the touch panel 7, the mode changeover switch 8, the nonvolatile memory 6, the creating apparatus I/F 9, the controller I/F 10, the memory 11, a CPU 28, and the ROM 31.

In display of display setting information and operation check, the display apparatus 25 according to this embodiment carries out the display of the display setting information and the operation check according to a combination of the display apparatus 25 and the controller 3 without using the screen data creating apparatus 26 and the program creating apparatus 55 (see FIG. 18). The CPU 28 controls the entire system based on a system program stored in the ROM 31.

The memory 11 functions as a work memory necessary when the CPU 28 executes the system program stored in the ROM 31. The memory 11 includes a data area, a device type area, a device code area, a condition device determination area, a position area, a display setting pointer area, and a format area (all of which are not shown in the figure).

The nonvolatile memory 6 functions as a storing unit configured to store screen data including display setting information. The mode changeover switch 8 functions as display mode switching means for switching a screen of the display unit 5 to a normal display mode for displaying apparatus information of an external apparatus and a display setting information display mode for displaying the display setting information.

A procedure for operation check for display setting information by the display apparatus 25 according to the present invention is explained. In the present invention, as in the related art, the display setting information is created in the screen data creating apparatus 26. The display setting information M1 created in the screen data creating apparatus 26 is stored in the nonvolatile memory 6 through the creating apparatus I/F 9 as shown in FIG. 20. The nonvolatile memory 6 further stores a format database obtained by forming format data as a database.

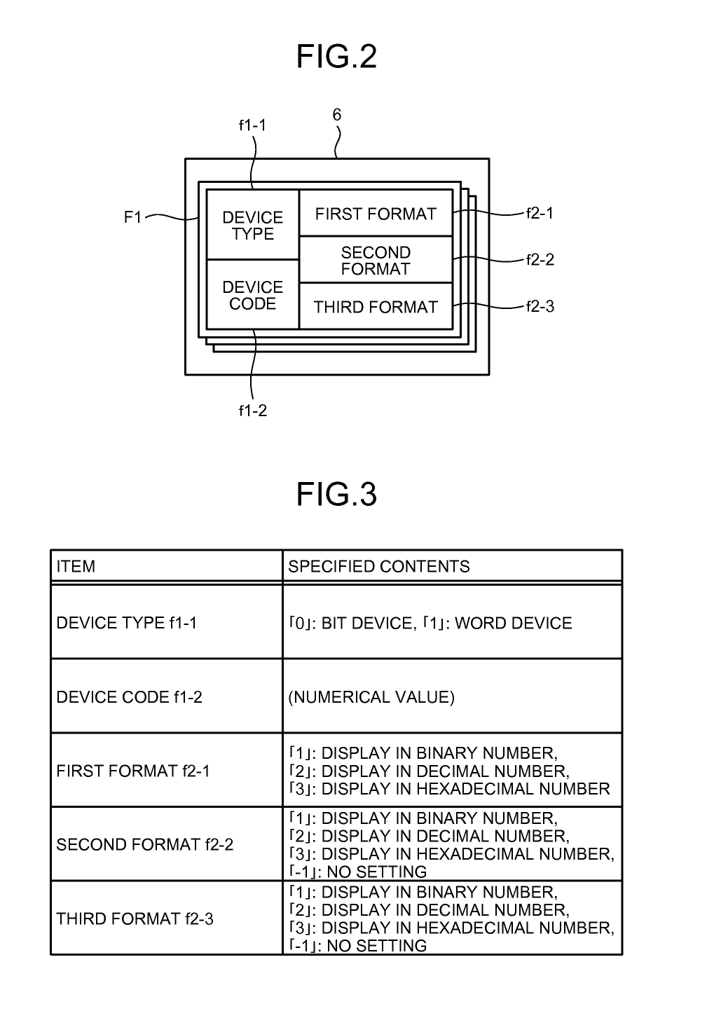

FIG. 2 is a diagram of an example of the format database stored in the nonvolatile memory. FIG. 3 is a diagram of an example of specified contents stored in respective items of the format database shown in FIG. 2. Format data F1 is stored in the nonvolatile memory 6 as a database in advance. The format database F1 can be created by the user in the screen data creating apparatus 26 and stored in the nonvolatile memory 6 via the creating apparatus I/F 9.

An area for storing the format data F1 in the nonvolatile memory 6 includes respective areas for storing a device type f1-1, a device code f1-2, a first format f2-1, a second format f2-2, and a third format f2-3. The format data F1 is present by the number of devices used for the display setting information M1. The format data F1 associates the device type f1-1, the device code f1-2, and the three formats f2-1, f2-2, and f2-3. The format data F1 is prepared separately for respective devices. Besides, the format data F1 can be prepared for a group including a plurality of devices.

The item of the device type f1-1 indicates whether a device allocated in the memory 4 of the controller 3 is a bit device or a word device. In this example, as specified contents of the device type f1-1, “0” represents a bit device and “1” represents a word device. The device code f2-2 is a code affixed to each of devices present in the memory 4 of the controller 3 and is represented by a numerical value.

The respective items of the first format f2-1, the second format f2-2, and the third format f2-3 define display forms of device values on the display unit 5. In this example, as specified contents of the first format f2-1, the second format f2-2, and the third format f2-3, “1” represents display in a binary number, “2” represents display in a decimal number, and “3” represents display in a hexadecimal number. In the respective items of the first format f2-1, the second format f2-2, and the third format f2-3, colors to be displayed on the display unit 5, the numbers of digits to be displayed, and the like can be displayed. The number of formats included in the format data F1 is not limited to three and only has to be plural.

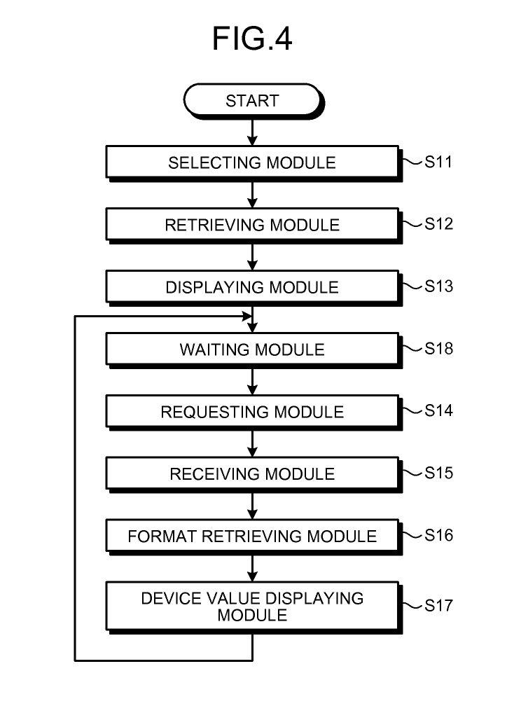

FIG. 4 is a diagram of an example of a module configuration of a system program in the display apparatus according to the first embodiment. In performing check of the display setting information M1 and the operation of the display apparatus 25, first, the user operates the mode changeover switch 8 of the display apparatus 25. When detecting that a state of the mode changeover switch 8 has changed according to the operation by the user, the CPU 28 executes a selecting module S11. The selecting module S11 is a step of storing, when the touch panel 7 of the display apparatus 25 is touched, a numerical value representing a touched position (see FIG. 22) in the position area of the memory 11 to transmit the numerical value to a retrieving module S12.

In the retrieving module S12, which is a display setting information retrieving step, the CPU 28 refers to the position area of the memory 11 and, when receiving the numerical value representing the touched position on the touch panel 7, retrieves display setting information stored in the nonvolatile memory 6 and specifies the display setting information M1 in which the position m6 coinciding with the received numerical value is set. In the retrieving module S12, the CPU 28 functions as display setting information retrieving means for retrieving display setting information from the nonvolatile memory 6. The CPU 28 stores, in the display setting pointer area of the memory 11, a storing position of the specified display setting information M1 in the nonvolatile memory 6 and clears the position area of the memory 11.

In a displaying module S13, which is a display setting information displaying step, the CPU 28 refers to the storing position of the nonvolatile memory 6 from the display setting pointer area of the memory 11 and instructs, based on the display setting information M1 of the storing position, the display unit 5 to display display setting contents. In the displaying module S13, the CPU 28 functions as display setting information displaying means for causing the display setting information M1 specified by the retrieval in the retrieving module S12 to be displayed on the screen in the display setting information display mode.

The display unit 5 displays the display setting contents, which are contents of the display setting information. The display unit 5 displays a numerical value as the ID number m1. The display unit displays wording “bit device” when the device type m2-1 is “0”, displays wording “word device” when the device type m2-1 is “1”, and displays nothing as the device type m2-1 when the device type m2-1 is “−1”.

The display unit 5 displays a numerical value of the device code m2-2 when the device type m2-1 is “0” or “1” and displays nothing as the device type m2-1 when the device type m2-1 is “−1”. The display unit 5 displays wording “condition bit device” when the condition device type m3-1 is “0”, displays wording “condition word device” when the condition device type m3-1 is “1”, and displays nothing as the condition device type m3-1 when the condition device type m3-1 is “−1”.

The display unit 5 displays a numerical value of the condition device code m3-2 when the device type m3-1 is “0” or “1” and displays nothing as the condition device code m3-2 when the device type m3-1 is “1”. The display unit 5 displays wording “not calculate” when the processing method m4 is “0”, displays wording “multiply with 1000” when the processing method m4 is “1”, and displays wording “divide by 1000” when the processing method m4 is “2”.

The display unit 5 displays wording “display a circle” when the component m5 is “1”, displays wording “display a numerical value” when the component m5 is “2”, and displays wording “transmit “1” to the controller” when the component m5 is “3”. The display unit 5 displays wording “display in a binary number” when the format m7 is “1”, displays wording “display in a decimal number” when the format m7 is “2”, and displays wording “display in a hexadecimal number” when the format m7 is “3”. The display unit 5 displays a numerical value as the position m6.

In the waiting module S18, the CPU 28 stands by for a touch on the touch panel 7 by the user. The CPU 28 stays on standby until the CPU 28 detects that the position of the device code displayed by the display unit 5 in the displaying module S13 or the position of the condition device code is touched on the touch panel 7. The user operates the touch panel 7 according to contents of the display setting information displayed on the display unit 5 by the displaying module S13.

When the position of the device code is touched in the waiting module S18, the CPU 28 refers to the device type m2-1 and the device code m2-2 of the display setting information M1 designated by the storing position stored in the display setting pointer area of the memory 11 from the nonvolatile memory 6. When the device type m2-1 is “0” or “1”, the CPU 28 stores a value of the device type m2-1 in the device type area of the memory 11 and stores a value of the device code m2-2 in the device code area. The CPU 28 stores “0” in the condition device determination area of the memory 11.

When the position of the condition device code is touched in the waiting module S18, the CPU 28 refers to the condition device type m3-1 and the condition device code m3-2 of the display setting information M1 designated by the storing position stored in the display setting pointer area of the memory 11 from the nonvolatile memory 6. When the condition device type m3-1 is “0” or “1”, the CPU 28 stores a value of the condition device type m3-1 in the device type area of the memory 11 and stores a value of the condition device code m3-2 in the device code area. The CPU 28 stores “1” in the condition device determination area of the memory 11.

In a requesting module S14, which is a device value requesting step, the CPU 28 requests, through the controller I/F 10, the controller 3 to transmit a device value. The CPU 28 requests a device value corresponding to the value stored in the device type area and the value stored in the device code area. In the requesting module S14, the CPU 28 functions as device value requesting means for requesting the controller 3 to transmit a device value retained by a device, which is an area in the memory 4. In the requesting module S14, the CPU 28 receives input operation performed in the waiting module S18 and requests transmission of a device value.

The controller 3 transmits the device value to the display apparatus 25 in response to the request from the CPU 28. In a receiving module S15, which is a device value receiving step, the CPU 28 receives the device value from the controller 3 via the controller I/F 10 and stores the device value in the data area of the memory 11. In the receiving module S15, the CPU 28 functions as device value receiving means for receiving the device value transmitted by the controller 3 in response to the request in the requesting module S14.

In a format retrieving module S16, the CPU 28 acquires a value stored in the device type area and a value stored in the device code area of the memory 11 and retrieves, from the format database of the nonvolatile memory 6, the format data F1 in which the acquired values and a device type and a device code coincide with each other. The CPU 28 passes a format included in the format data F1 obtained by the retrieval to a device value displaying module S17.

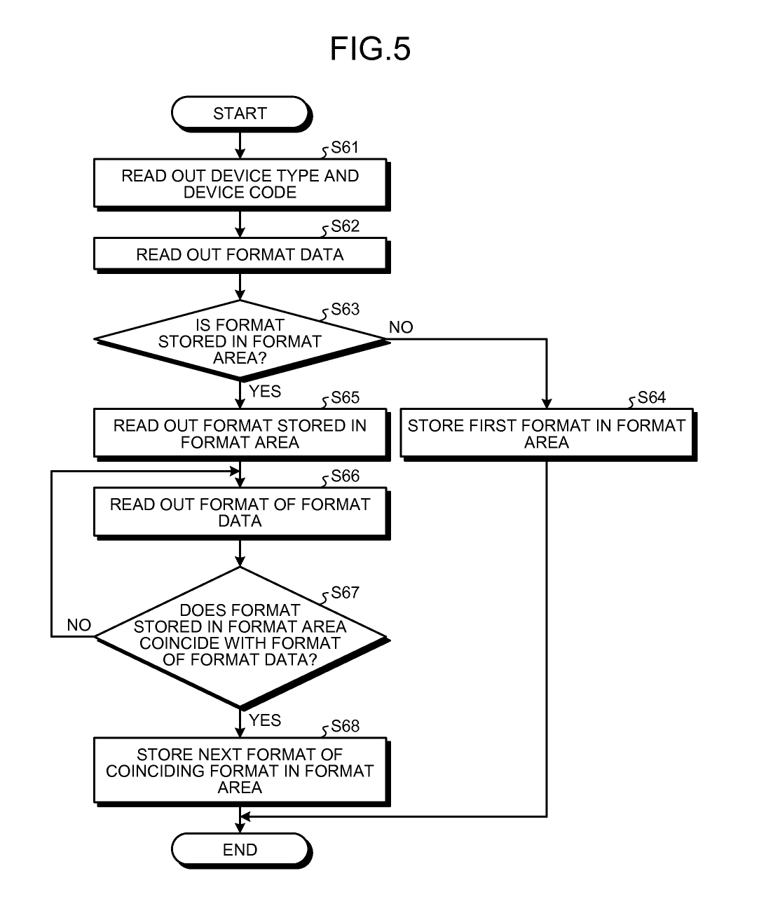

FIG. 5 is a flowchart for explaining a detailed processing procedure by the format retrieving module. First, the CPU 28 reads out a value stored in the device type area and a value stored in the device code area of the memory 11 (step S61). The CPU 28 reads out, from the format database of the nonvolatile memory 6, the format data F1 in which both of the value of the device type and the value of the device code acquired at step S61 respectively coincide with the device type f1-1 and the device code f1-2 (step S62).

Subsequently, the CPU 28 determines whether a format is stored in the format area of the memory 11 (step S63). When a format is not stored in the format area (No at step S63), the CPU 28 reads out the first format f2-1 in the format data F1 read out at step S2 and stores the first format f2-1 in the format area of the memory 11 (step S64). When a format is stored in the format area (Yes at step S63), the CPU 28 reads out the format stored in the format area (step S65).

The CPU 28 reads out the first format f2-1 in the format data F1 present in the nonvolatile memory 6 (step S66). The CPU 28 determines whether the format stored in the format area of the memory 11 and the first format f2-1 read out at step S66 coincide with each other (step S67).

When the format stored in the format area of the memory 11 and the first format f2-1 do not coincide with each other (No at step S67), the CPU 28 reads out the second format f2-2 in the format data F1 present in the nonvolatile memory 6 (step S66) and carries out determination at step S67. When the format stored in the format area of the memory 11 does not coincide with the second format f2-2 either (No at step S67), the CPU 28 carries out the readout at step S66 and the determination at step S67 concerning the third format f2-3 as well. In this way, the CPU 28 repeats the determination at step S67 while sequentially changing the format read out at step S66 until the format stored in the format area and the format present in the format data F1 coincide with each other. The order of the formats read out at step S66 is set in the order of the first format f2-1, the second format f2-2, and the third format f2-3.

When the format stored in the format area of the memory 11 and the format present in the format data F1 coincide with each other (Yes at step S67), the CPU 28 stores the next format of the coinciding format in the format area (step S68). The “next format” is determined, for example, according to the readout order at step S66. In this example, when the coinciding format is the first format f2-1, the CPU 28 stores the second format f2-2, which is the next format of the first format f2-1, in the format area. When the coinciding format is the second format f2-2, the CPU 28 stores the third format f2-3, which is the next format of the second format f2-2, in the format area. When the coinciding format is the third format f2-3, the CPU 28 stores the first format f2-1, which is the next format of the third format f2-3, in the format area.

In this way, every time the format retrieving module S16 is executed, the formats are stored in the format area of the memory 11 from the format data F1 present in the nonvolatile memory 6 in the order of the first format f2-1, the second format f2-2, the third format f2-3, the first format f2-1, . . . . The format stored in the format area is sequentially changed.

In the device value displaying module S17, which is a device value displaying step, the CPU 28 causes the display unit 5 to display, according to the format stored in the format area of the memory 11 in the format retrieving module S16, the device value stored in the data area of the memory 11 by the receiving module S15. In the device value displaying module S17, the CPU 28 functions as device value displaying means for causing the device value received in the receiving module S15 to be displayed on the screen. In the device value displaying module S17, the CPU 28 can sequentially change the format of the device value among a plurality of formats of the format data F1 retrieved from the format database.

For example, when a value of the condition device determination area of the memory 11 is “0”, the CPU 28 causes the display unit 5 to display, beside a device code that the displaying module S13 has caused the display unit 5 to display, a device value according to a format stored in the format area. When the value of the condition device area determination of the memory 11 is “1”, the CPU 28 causes the display unit 5 to display, beside a condition device code that the displaying module S13 has caused the display unit 5 to display, a device value according to the format stored in the format area.

Further, when the value of the condition device determination area of the memory 11 is “0”, the CPU 28 causes the display unit 5 to display a processed value beside a processing method that the displaying module S13 causes the display unit 5 to display. In this case, the processed value is a value obtained by processing a device value stored in the data area of the memory 11 according to the processing method m4 present in the display setting information M1 designated by a storing position stored in the display setting pointer area of the memory 11 in the nonvolatile memory 6. In such a processed value displaying step, the CPU 28 functions as processed value displaying means for calculating a device value according to the processing method included in the display setting means specified by the retrieval in the retrieving module S12 and causing the display unit 5 to display a result of the calculation as the processed value.

Thereafter, the CPU 28 executes the waiting module S18 again. The user can request update of the device value displayed on the display unit 5 and change of the format of the device value by touching the device code or the condition device code that the displaying module S13 has caused the display unit 5 to display.

As a specific example, an operation check for the display setting information (B) set in the system of the production line shown in FIG. 17 is explained. The display setting information (A), (B), and (C) is created by the screen data creating apparatus 26. The display setting information (A), (B), and (C) created by the screen data creating apparatus 26 is stored in the nonvolatile memory 6 via the creating apparatus I/F 9. The display setting information (A), (B), and (C) is stored as shown in FIG. 23 in the nonvolatile memory 6.

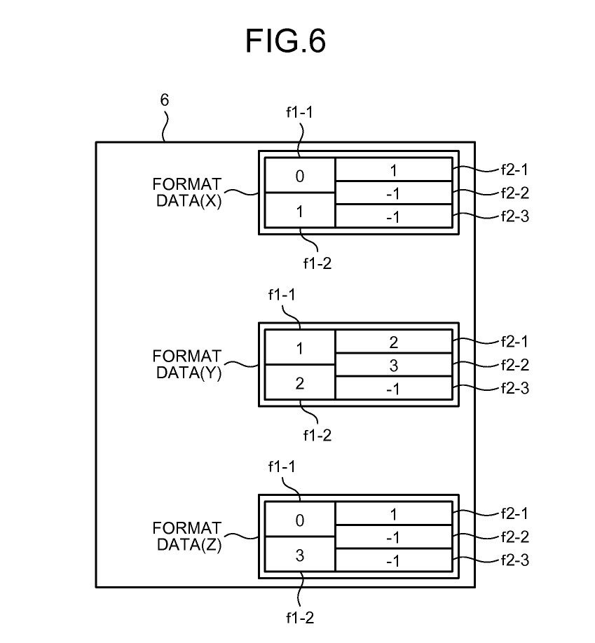

FIG. 6 is a diagram of an example of a format database corresponding to the display setting information (A), (B), and (C). When a value of the device type m2-1 or the condition device type m3-1 of the display setting information (A), (B), and (C) is “0” indicating a bit device, the first format f2-1 is set to “1”, the second format f2-2 is set to “−1”, and the third format f2-3 is set to “−1”. When the value of the device type m2-1 or the condition device type m3-1 is “1” indicating a word device, the first format f2-1 is set to “2”, the second format f2-2 is set to “3”, and the third format f2-3 is set to “−1”.

The format database is created according to such rules. The created format database is stored in the nonvolatile memory 6. The ID number m1 of the display setting information M1 can be added to format data. In this case, when the same device type and the same device code are present in a plurality of kinds of display setting information, it is possible to create format data for each of the kinds of display setting information.

Format data (X) corresponds to the device type m2-1 and the device code m2-2 of the display setting information (A). Because a value of the device type m2-1 of the display setting information (A) is “0”, “1” is stored in the first format f2-1, “−1” is stored in the second format f2-2, and “−1” is stored in the third format f2-3 of the format data (X). “0”, which is the value of the device type m2-1 of the display setting information (A), is stored in the device type f1-1 of the format data (X). “1”, which is the value of the device code m2-2 of the display setting information (A), is stored in the device code f1-2 of the format data (X).

Format data (Y) corresponds to the device type m2-1 and the device code m2-2 of the display setting information (B). Because a value of the device type m2-1 of the display setting information (B) is “1”, “2” is stored in the first format f2-1, “3” is stored in the second format f2-2, and “−1” is stored in the third format f2-3 of the format data (Y). “1”, which is the value of the device type m2-1 of the display setting information (B), is stored in the device type f1-1 of the format data (Y). “2”, which is the value of the device code m2-2 of the display setting information (B), is stored in the device code f1-2 of the format data (Y).

The values of the device type m2-1 and the device code m2-2 coincide with each other in the display setting information (C) and the display setting information (A). The format data (X) corresponds to the device type m2-1 and the device code m2-2 of the display setting information (A) and corresponds to the device type m2-1 and the device code m2-2 of the display setting information (C) as well.

Format data (Z) corresponds to the condition device type m3-1 and the condition device code m3-2 of the display setting information (C). Because a value of the condition device type m3-1 of the display setting information (C) is “0”, “1” is stored in the first format f2-1, “−1” is stored in the second format f2-2, and “−1” is stored in the third format f2-3 of the format data (Z). “0”, which is the value of the device type m2-1 of the display setting information (C), is stored in the device type f1-1 of the format data (Z). “3”, which is the value of the device code m2-2 of the display setting information (C), is stored in the device code f1-2 of the format data (Z).

In the operation check for the display setting information (B), first, the user operates the mode changeover switch 8 of the display apparatus 25 and switches the screen from the normal display mode to the display setting information display mode. Subsequently, the user touches the position of a number “31” shown in FIG. 22 on the touch panel 7 of the display apparatus 25. The CPU 28 stores the value “31” in the position area of the memory 11. The CPU 28 retrieves, out of the display setting information stored in the nonvolatile memory 6, display setting information having the position m6 coinciding with the value “31” stored in the position area and acquires the display setting information (B). The CPU 28 stores, in the display setting pointer area of the memory 11, a storing position of the display setting information (B) in the nonvolatile memory 6.

The CPU 28 reads out, from the nonvolatile memory 6, the display setting information (B) designated by the storing position stored in the display setting pointer area. The CPU 28 causes the display unit 5 to display “2” as the ID number m1, display wording “word device” as the device type m2-1, display “#2” as the device code m2-2, display wording “divide by 1000” as the processing method m4, display wording “numerical value” as the component m5, display wording “display in decimal number” as the format m7, and display “31” as the position m6.

When recognizing that the position of a device code displayed earlier is touched, the CPU 28 reads out, from the nonvolatile memory 6, the value “1” of the device type m2-1 and the value “2” of the device code m2-2 of the display setting information (B) designated by the storing position stored in the display setting pointer area. The CPU 28 stores “1” in the device type area, stores “2” in the device code area, and stores “0” in the condition device determination area of the memory 11.

Subsequently, the CPU 28 requests, through the controller I/F 10, the controller 3 for a device value of the word device #2, which is a device corresponding to the value “1” of the device type area and the value “2” of the device code area of the memory 11. The CPU 28 stores, in the data area of the memory 11, the device value of the word device #2 received from the controller 3 through the controller I/F 10.

The CPU 28 reads out the value “1” stored in the device type area and the value “2” stored in the device code area of the memory 11. The CPU 28 retrieves, from the format database stored in the nonvolatile memory 6, format data including the device type f1-1 and the device code f1-2 coinciding with these values and obtains the format data (Y). Because a format is not stored in the format area of the memory 11, the CPU 28 stores, in the format area of the memory 11, the value “2” of the first format f2-1 within the format data (Y).

Because the value of the condition device determination area of the memory 11 is “0”, the CPU 28 reads out a device value of the “word device #2” from the data area of the memory 11. Because the value “2” stored in the format area of the memory 11 designates display in a decimal number, the CPU 28 displays the read-out device value in a decimal number. The display unit 5 displays the device value beside the device code.

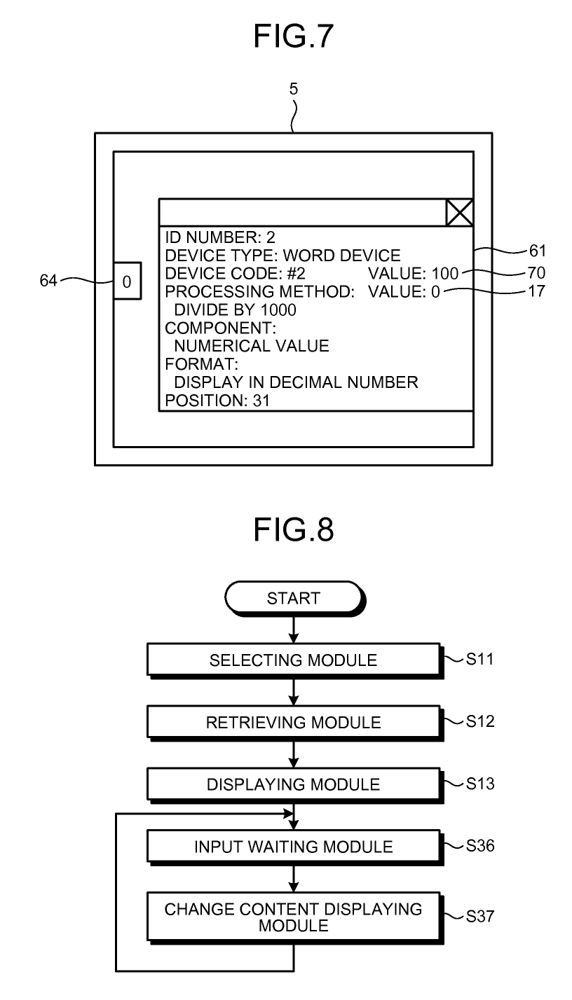

FIG. 7 is a diagram of a display example of display setting contents in the display setting information (B) and a device value of the word device #2. The display unit 5 displays, together with the display setting contents 61 of the display setting information (B), a device value 70 of the word device #2 used in the display setting information (B). In this example, the device value 70 is “100”. A processed value 17 is a value obtained by processing the device value 70 of the word device #2 according to “divide by 1000”, which is the processing method m4 in the display setting information (B).

When the display of the position 64 of “31” on the display unit 5 shown in FIG. 7 does not change from “0” during the operation of the system of the production line shown in FIG. 17, the user cannot determine from only the display of the position 64 whether this is because the device value of the word device #2 is smaller than 1000 or because the communication between the display apparatus 25 and the controller 3 has been interrupted.

In this embodiment, the device value 70 is displayed as “100” by the device value displaying means. Therefore, the user can recognize that the display of the position 64 does not change from “0” because the device value of the word device #2 is smaller than 1000 and that the display apparatus 25 can receive the device value from the controller 3. Because “0”, which is the processed value 17 by the processing method designated by the display setting information (B), and the value “0” displayed in the position 64 coincide with each other, the user can confirm that there is no problem in contents of the display setting information (B).

As explained above, the display apparatus 25 displays, together with the display setting information specified by the retrieval, the device value specified by the display setting information. In this embodiment, it is possible to check the display setting information and a deficiency of the system including the display apparatus without using a screen data creating apparatus and a program creating apparatus. Consequently, there is an effect that it is possible to easily and quickly grasp problems such as an error in the display setting information and a deficiency of the system, which are hard to determine only with the display of the display setting information.

For example, when display of a numerical value in the display unit 5 is limited to maximum four digits, it is assumed that a device value of the word device #2 is a decimal number “10000”. In the display setting information (B), a value stored in the second format f2-2, which is the next format of the first format f2-1, is “3”, which indicates display in a hexadecimal number. When the user touches a position where a device code is displayed on the touch panel 7, the CPU 28 causes the display unit 5 to display, as the device value of the word device #2, “2710” obtained by converting the decimal number “10000” into a hexadecimal number. Because the number of display digits can be adjusted as appropriate in this way, the user can correctly grasp the device number.

### Second Embodiment

In a second embodiment, functions different from the functions in the first embodiment are explained. Components same as the components in the first embodiment are denoted by the same reference numerals and signs. Redundant explanation of the components is omitted as appropriate. All of the block configuration shown in FIG. 1, the format database shown in FIG. 2, and the specified contents shown in FIG. 3 are the same in the second embodiment.

FIG. 8 is a diagram of an example of a module configuration of a system program in a display apparatus according to a second embodiment. The selecting module S11, the retrieving module S12, and the displaying module S13 are operations same as the operations in the first embodiment.

In an input waiting module S36, the CPU 28 stays on standby until the CPU 28 detects that a position designated by display setting information has been touched on the touch panel 7. When detecting that the position designated by the position setting information has been touched, the CPU 28 retrieves, from the display setting information stored in the nonvolatile memory 6, display setting information having the position m6 coinciding with a numerical value representing the touched position (see FIG. 22). The CPU 28 stores, in the display setting pointer area of the memory 11, a storing position of the retrieved display setting information M1 in the nonvolatile memory 6.

In a change content displaying module S37, which is a device value change content displaying step, the CPU 28 reads out the condition device type m3-1, the condition device code m3-2, the processing method m4, and the component m5 from the display setting information M1 designated by the storing position stored in the display setting pointer area of the memory 11. The CPU 28 acquires change content of a device value transmitted to the controller 3 and causes the display unit 5 to display the change content of the device value. In the change content displaying module S37, the CPU 28 functions as device value change content displaying means for causing change content designated concerning the change of the device value specified from the display setting information to be displayed on the screen. Thereafter, the CPU 28 executes the input waiting module S36 again.

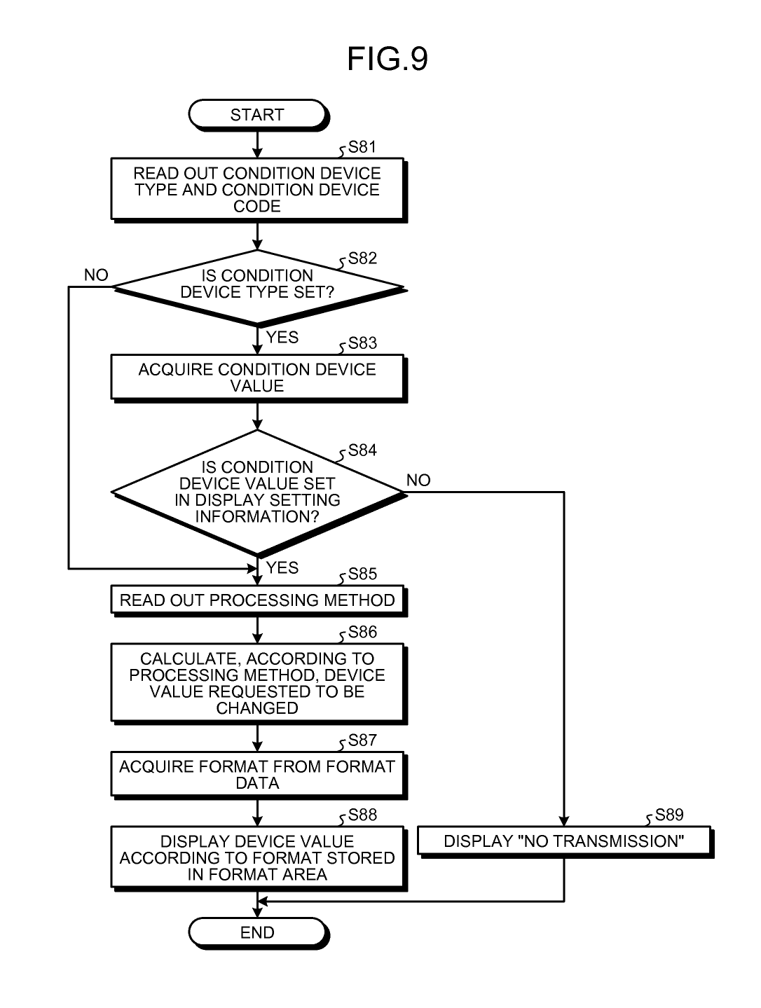

FIG. 9 is a flowchart for explaining a detailed processing procedure by the change content displaying module. First, the CPU 28 reads out the condition device type m3-1 and the condition device code m3-2 from the display setting information M1 designated by the storing position stored in the display setting pointer area of the memory 11 (step S81).

Subsequently, the CPU 28 determines whether a condition device type is set (step S82). When the condition device type is set (Yes at step S82), i.e., in this example, when the condition device type m3-1 is “0” or “1”, the CPU 28 stores a value of the condition device type m3-1 in the device type area of the memory 11. The CPU 28 stores a value of the condition device code m3-2 in the device code area of the memory 11.

After storing the values in the device type area and the device code area of the memory 11, the CPU 28 requests, through the controller I/F 10, the controller 3 for a condition device value. The CPU 28 acquires the condition device value through the controller I/F 10 by receiving the condition device value from the controller 3 (step S83). The CPU 28 stores the acquired condition device value in the data area of the memory 11.

When the condition device type is not set (No at step S82), i.e., in this example, when the value of the condition device type m3-1 is “−1”, the CPU 28 executes processing at step S85 without acquiring the condition device value.

After acquiring the condition device value at step S83 and storing the condition device value in the data area of the memory 11, the CPU 28 determines whether the value of the condition device stored in the data area is the value set in the display setting information M1 (step S84). When the value of the condition device type m3-1 is “0” indicating a bit device, the CPU 28 determines whether the condition device value is “1”. When the value of the condition device type 3m-1 is “1” indicating a word device, the CPU 28 determines whether the value of the data area is the same as the condition device value specified in the display setting information M1.

When the condition device value stored in the data area is the value set in the display setting information M1 (Yes at step S84), the CPU 28 reads out a value of the processing method m4 of the display setting information M1 (step S85). When the value of the processing method m4 is “1” or “2”, the CPU 28 calculates, with a calculation method corresponding to the processing method m4, a device value before processing for transmitting a change request to the controller 3 according to designation by the component m5 of the display setting information M1 (step S86). The CPU 28 stores a processed value obtained by the calculation in the data area of the memory 11. When the value of the processing method m4 is “0”, the CPU 28 directly stores, in the data area of the memory 11, the device value before processing for transmitting the change request to the controller 3 according to the designation by the component m5 of the display setting information M1.

Subsequently, the CPU 28 reads out the device type m2-1 and the device code m2-2 from the display setting information M1 designated by the storing position stored in the display setting pointer area of the memory 11. The CPU 28 stores a value of the read-out device type m2-1 in the device type area of the memory 11. The CPU 28 stores the read-out device code m2-2 in the device code area of the memory 11.

The CPU 28 retrieves, from the format database stored in the nonvolatile memory 6, format data including the device type f1-1 coinciding with the value stored in the device type area and the device code f1-2 coinciding with the value stored in the device code area. The CPU 28 acquires a format from the retrieved format data (step S87) and stores the format in the format area of the memory 11. The acquisition of the format by the retrieval of the format data at step S87 and the storage of the format in the format area are the same as the format retrieving module S16 in the first embodiment (see FIG. 4).

Subsequently, the CPU 28 causes the display unit 5 to display the device value stored in the data area of the memory 11 according to the format stored in the format area of the memory 11. The display unit 5 displays the device value beside the display of “component” among the display setting contents.

When the condition device value is not the value set in the display setting information (No at step S84), the CPU 28 causes the display unit 5 to display a message “no transmission” beside the display of “component” on the display unit 5 (step S89).

As a specific example, an operation check for the display setting information (C) set in the system of the production line shown in FIG. 17 is explained. The display setting information (A), (B), and (C) is created by the screen data creating apparatus 26. The display setting information (A), (B), and (C) created by the screen data creating apparatus 26 is stored in the nonvolatile memory 6 via the creating apparatus I/F 9. The display setting information (A), (B), and (C) is stored as shown in FIG. 23 in the nonvolatile memory 6.

It is assumed that a format database corresponding to the display setting information (A), (B), and (C) is the same as the format database in the first embodiment shown in FIG. 6. The format data (X) corresponds to the device type m2-1 and the device code m2-2 of the display setting information (A) and the display setting information (C). The format data (Y) corresponds to the device type m2-1 and the device code m2-2 of the display setting information (B). The format data (Z) corresponds to the condition device type m3-1 and the condition device code m3-2 of the display setting information (C).

In the operation check for the display setting information (C), first, the user operates the mode changeover switch 8 of the display apparatus 25 and switches the display of the screen from the normal display mode to the display setting information display mode. Subsequently, the user touches the position of a number “80” shown in FIG. 22 on the touch panel 7 of the display apparatus 25. The CPU 28 stores the value “80” in the position area of the memory 11. The CPU 28 retrieves, out of the display setting information stored in the nonvolatile memory 6, display setting information having the position m6 coinciding with the value “80” stored in the position area and acquires the display setting information (C). The CPU 28 stores, in the display setting pointer area of the memory 11, a storing position of the display setting information (C) in the nonvolatile memory 6.

The CPU 28 reads out, from the nonvolatile memory 6, the display setting information (C) designated by the storing position stored in the display setting pointer area. The CPU 28 causes the display unit 5 to display “3” as the ID number m1, display wording “bit device” as the device type m2-1, display “#1” as the device code m2-2, display wording “bit device” as the condition device type m3-1, display “#3” as the condition device code m3-2, display wording “not calculate” as the processing method m4, display wording “transmit “1” to the controller” as the component m5, and display “80” as the position m6.

When detecting that the position of the number “80” is further touched on the touch panel 7, the CPU 28 retrieves display setting information in which the position m5 is “80” out of the display setting information stored in the nonvolatile memory 6 and acquires the display setting information (C). The CPU 28 stores, in the display setting pointer area of the memory 11, the storing position of the display setting information (C) in the nonvolatile memory 6.

Further, the CPU 28 reads out, from the nonvolatile memory 6, a value “0” of the condition device type m3-1 and a value “3” of the condition device code m3-2 of the display setting information (C) designated by the storing position stored in the display setting pointer area. Because the value of the condition device type m3-1 is a value other than “−1” indicating no setting, the CPU 28 stores the value “0” of the condition device type m3-1 in the device type area of the memory 11 and stores the value “3” of the condition device code m3-2 in the device code area of the memory 11.

The CPU 28 requests, through the controller I/F 10, the controller 3 for a condition device value of the bit device #3, which is a condition device corresponding to the value “0” of the device type area and the value “3” of the device code area of the memory 11. The CPU 28 stores, in the data area of the memory 11, the condition device value of the bit device #3 received from the controller 3 through the controller I/F 10.

When the condition device value of the bit device #3 is “0”, the condition device value does not correspond to a value for executing operation designated by the component m5 of the display setting information (C). In this case, the CPU 28 causes the display unit 5 to display wording “no transmission” beside wording “components” in the display unit 5.

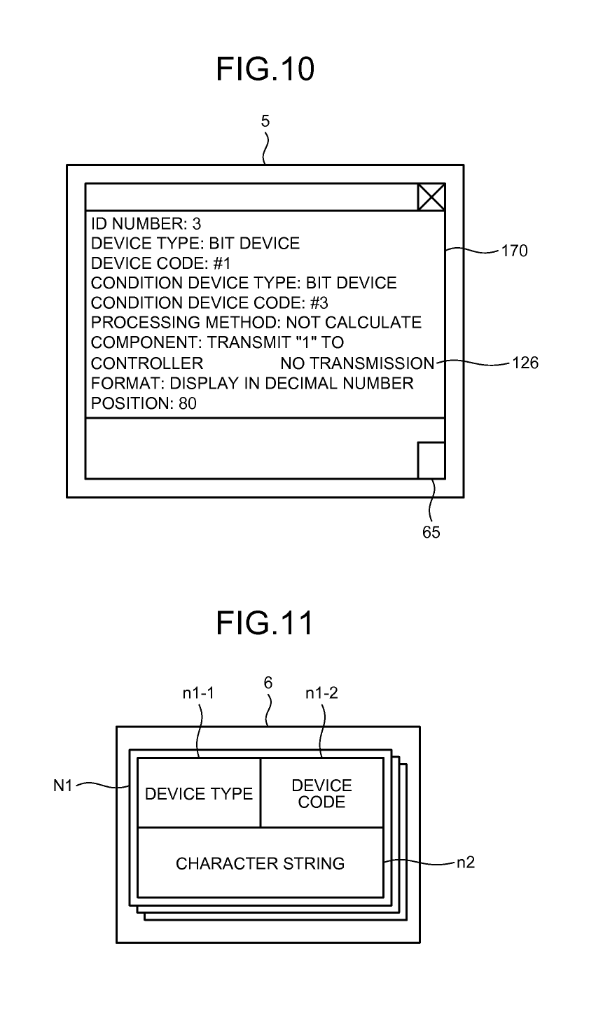

FIG. 10 is a diagram of a display example of display setting contents in the display setting information (C) and a condition device value of the bit device #3. The display unit 5 displays, together with display setting contents 170 of the display setting information (C), device value change content 126 designated in the display setting information (C). In this example, a condition device value of the bit device #3 used in the display setting information (C) is “0” and the device value change content 126 is “not transmission”.

In this embodiment, when the conveyor 52 does not operate even if the user touches the position 65 on the touch panel 7, the user can recognize, referring to the device value change content 126, whether the display apparatus 25 has requested the controller 3 to change a device value. When recognizing that the change of the device value has not been requested, the user can realize early solution of a problem by investigating a condition device for changing the device value. In this embodiment, as in the first embodiment, it is possible to easily and quickly grasp problems such as an error in the display setting information and a deficiency of the system.

### Third Embodiment

In a third embodiment, functions different from the functions in the first embodiment are explained. Components same as the components in the first embodiment are denoted by the same reference numerals and signs. Redundant explanation of the components is omitted as appropriate. All of the block configuration shown in FIG. 1, the format database shown in FIG. 2, and the specified contents shown in FIG. 3 are the same in the third embodiment.

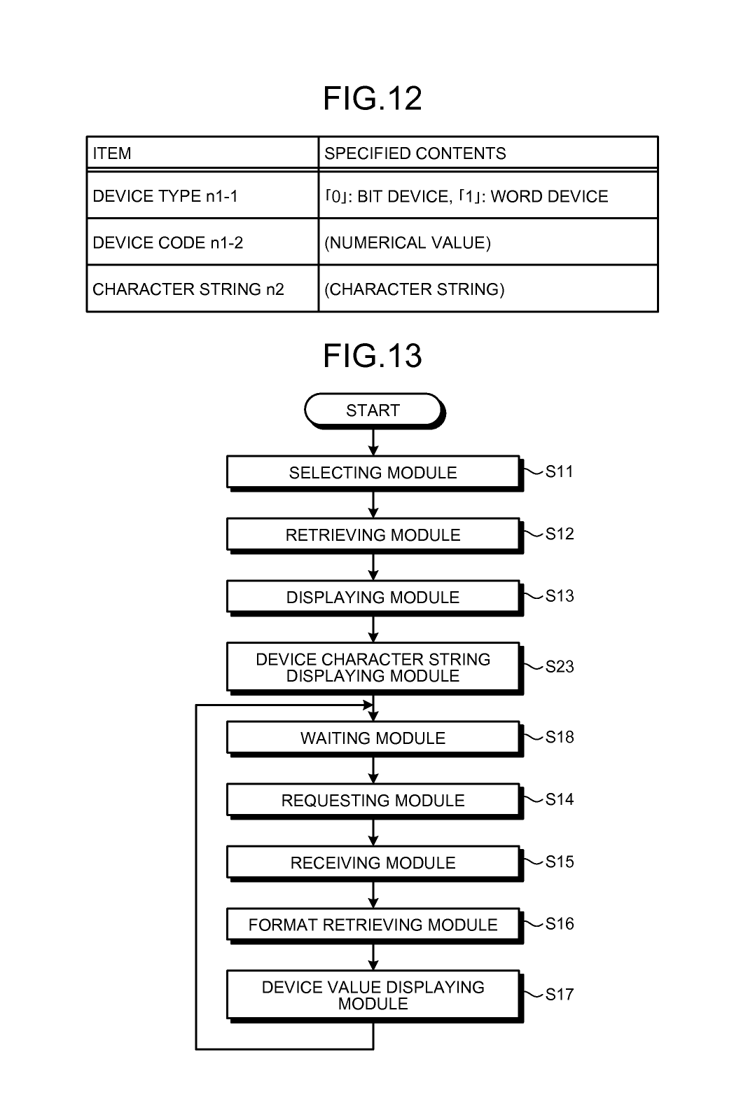

FIG. 11 is a diagram of an example of a device character string database stored in a nonvolatile memory. FIG. 12 is a diagram of an example of specified contents of values stored in respective items of the device character string database shown in FIG. 11. The device character string database is a database of device character string data for converting a device code into a character string.

Device character string data N1 is stored in the nonvolatile memory 6 as a database in advance. The device character string data N1 can be created by a user in the screen data creating apparatus 26 and stored in the nonvolatile memory 6 via the creating apparatus I/F 9.

An area for storing the device character string data N1 in the nonvolatile memory 6 includes areas for storing a device type n1-1, a device code n1-2, and a character string n2. The device character string data N1 is present by the number of devices used in display setting information.

The device type n1-1 corresponds to the device type m2-1 or the condition device type m3-1 of the display setting information M1. A value of the device type n1-1 is the same as a value of the device type m2-1 or a value of the condition device type m3-1 of the display setting information M1. The device code n1-2 corresponds to the device code m2-2 or the condition device code m3-2 of the display setting information M1. A value of the device code n1-2 is the same as a value of the device code m2-2 or a value of the condition device code m3-2 of the display setting information M1.

The character string n2 is a character string for specifying the device code n1-2. The character string n2 can be used in the program creating apparatus 55 instead of a device code as a character string for specifying the device code. The character string n2 can be set as an arbitrary character string as well for the user to specify the device code n1-2.

FIG. 13 is a diagram of an example of a module configuration of a system program in a display apparatus according to the third embodiment. The selecting module S11, the retrieving module S12, and the displaying module S13 are operations same as the operations in the first embodiment.

In a device character string displaying module S23, the CPU 28 acquires the device type m2-1 and the device code m2-2 or the condition device type m3-1 and the condition device code m3-2 from the display setting information M1 designated by a storing position stored in the display setting pointer area of the memory 11. The CPU 28 retrieves, in the device character string data stored in the nonvolatile memory 6, device character string data including the device type n1-1 and the device code n1-2 coinciding with the thus acquired device type m2-1 and the device code m2-2 or the condition device type m3-1 and the condition device code m3-2.

Further, the CPU 28 causes the display unit 5 to display the character string n2 of the device character string data N1 obtained by the retrieval. In the device character string displaying module S23, which is a device character string displaying step, the CPU 28 functions as device character string displaying means for displaying a character string retrieved from the device character string database using a device code included in display setting information specified by retrieval in the retrieving module S12.

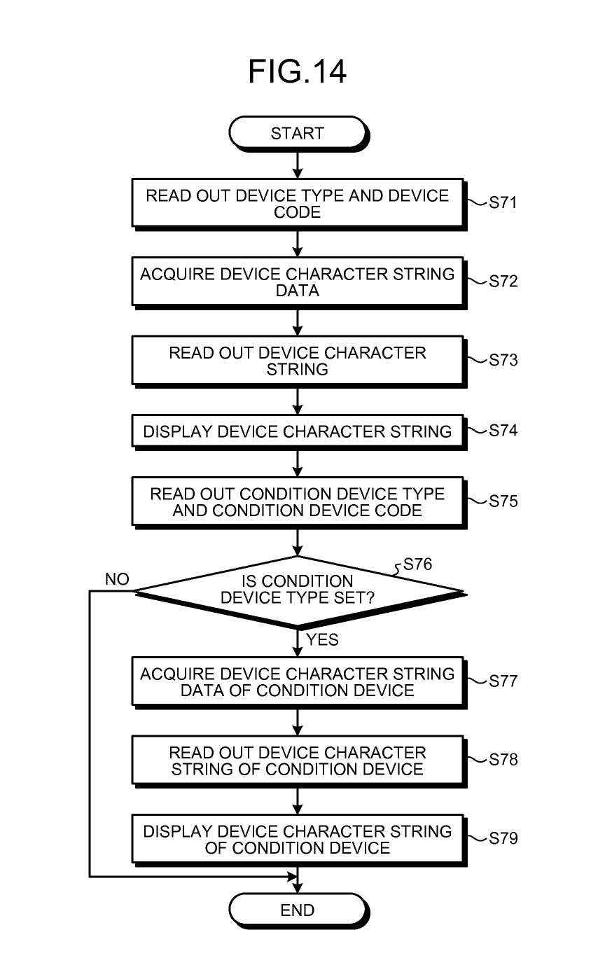

FIG. 14 is a flowchart for explaining a detailed processing procedure by the device character string displaying module. First, the CPU 28 reads out the device type m2-1 and the device code m2-2 from the display setting information M1 designated by the storing position stored in the display setting pointer area of the memory 11 (step S71).

The CPU 28 retrieves, from the device character string database of the nonvolatile memory 6, the device character string data N1 in which both values of the device type m2-1 and the device code m2-2 acquired at step S71 respectively coincide with the device type n1-1 and the device code n1-2 and acquires the device character string data N1 (step S72).

The CPU 28 reads out the character string n2 of the device character string data N1 acquired at step S72 (step S73). The CPU 28 causes the display unit 5 to display the character string n2 read out at step S73 (step S74).

Subsequently, the CPU 28 reads out the condition device type m3-1 and the condition device code m3-2 from the display setting information M1 designated by the storing position stored in the display setting pointer area of the memory 11 (step S75).

The CPU 28 determines whether a condition device type is set (step S76). When the condition device type is set (Yes at step S76), i.e., in this example, when the condition device type m3-1 is “0” or “1”, the CPU 28 retrieves the device character string data N1 in which both values of the condition device type m3-1 and the condition device code m3-2 acquired at step S75 respectively coincide with the device type n1-1 and the device code n1-2 from the device character string database in the non-volatile memory 6, and acquires the device character string data N1 (step S77).

The CPU 28 reads out, concerning a condition device, the character string n2 of the device character string data N1 acquired at step S77 (step S78). The CPU 28 causes, concerning the condition device, the display unit 5 to display the character string n2 read out at step S78 (step S79) and ends the processing.

When there is no setting of a condition device type (No at step S76), i.e., in this example, a value of the condition device type m3-1 is “−1”, the CPU 28 ends the processing without performing readout of a character string related to the condition device and display of the character string on the display unit 5.

The waiting module S18, the requesting module S14, the receiving module S15, the format retrieving module S16, and the device value displaying module S17 are the same as those in the first embodiment.

As a specific example, an operation check for the display setting information (C) set in the system of the production line shown in FIG. 17 is explained. The display setting information (A), (B), and (C) is created by the screen data creating apparatus 26. The display setting information (A), (B), and (C) created by the screen data creating apparatus 26 is stored in the nonvolatile memory 6 via the creating apparatus I/F 9. The display setting information (A), (B), and (C) is stored as shown in FIG. 23 in the nonvolatile memory 6.

It is assumed that a format database corresponding to the display setting information (A), (B), and (C) is the same as the format database in the first embodiment shown in FIG. 6. The format data (X) corresponds to the device type m2-1 and the device code m2-2 of the display setting information (A) and the display setting information (C). The format data (Y) corresponds to the device type m2-1 and the device code m2-2 of the display setting information (B). The format data (Z) corresponds to the condition device type m3-1 and the condition device code m3-2 of the display setting information (C).

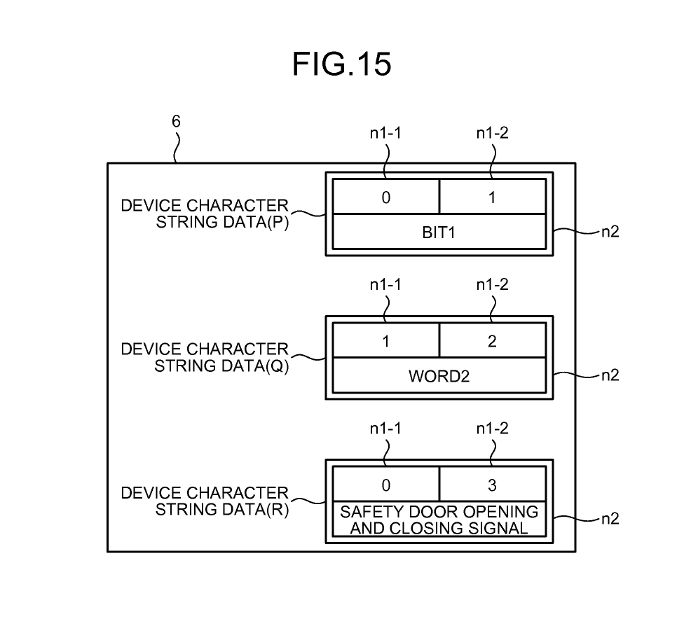

FIG. 15 is a diagram of an example of a device character string database corresponding to the display setting information (A), (B), and (C). Device character string data (P) corresponds to the device type m2-1 and the device code m2-2 of the display setting information (A). “0” is stored in the device type n1-1 and “1” is stored in the device code n1-2. “BIT1” is set in the character string n2 of the device character string data (P) as a character string for specifying the device code “1”.

Device character string data (Q) corresponds to the device type m2-1 and the device code m2-2 of the display setting information (B). “1” is stored in the device type n1-1 and “2” is stored in the device code n1-2. “WORD2” is set in the character string n2 of the device character string data (Q) as a character string for specifying the device code “2”.

The values of the device type m2-1 and the device code m2-2 coincide with each other in the display setting information (C) and the display setting information (A). The device character string data (P) corresponds to the device type m2-1 and the device code m2-2 of the display setting information (A) and corresponds to the device type m2-1 and the device code m2-2 of the display setting information (C) as well.

Device character string data (R) corresponds to the condition device type m3-1 and the condition device code m3-2 of the display setting condition (C). “0” is stored in the device type n1-1 and “3” is stored in the device code n1-2. “Safety door opening and closing signal” is set in the character string n2 of the device character string data (R) as a character string for specifying the device code “3”. It is assumed that the device character string data (P), (Q), and (R) are created by the user in the screen data creating apparatus 26 and stored in the nonvolatile memory 6 via the creating apparatus I/F 9.

In the operation check for the display setting information (C), first, the user operates the mode changeover switch 8 of the display apparatus 25 and switches the display of the screen from the normal display mode to the display setting information display mode. Subsequently, the user touches the position of the number “80” shown in FIG. 22 on the touch panel 7 of the display apparatus 25. The CPU 28 stores the value “80” in the position area of the memory 11. The CPU 28 retrieves, out of the display setting information stored in the nonvolatile memory 6, display setting information having the position m6 coinciding with the value “80” stored in the position area and acquires the display setting information (C). The CPU 28 stores, in the display setting pointer area of the memory 11, a storing position of the display setting information (C) in the nonvolatile memory 6.

The CPU 28 reads out, from the nonvolatile memory 6, the display setting information (C) designated by the storing position stored in the display setting pointer area. The CPU 28 causes the display unit 5 to display “3” as the ID number m1, display wording “bit device” as the device type m2-1, display “#1” as the device code m2-2, display wording “bit device” as the condition device type m3-1, display “#3” as the condition device code m3-2, display wording “not calculate” as the processing method m4, display wording “transmit “1” to the controller” as the component m5, and display “80” as the position m6.

The CPU 28 reads out the device type m2-1 and the device code m2-2 of the display setting information (C) from the nonvolatile memory 6. The CPU 28 retrieves, from the device character string database stored in the nonvolatile memory 6, device character string data including the device type m2-1 and the device code m2-2 coinciding with the device type m2-1 and the device code m2-2 read out from the nonvolatile memory 6 and obtains the device character string data (P). The CPU 28 obtains the character string n2 “BIT1” from the acquired device character string data (P) and causes the display unit 5 to display the character string n2 “BIT1”.

Subsequently, the CPU 28 reads out the condition device type m3-1 and the condition device code m3-2 of the display setting information (C). Because the value of the condition device type m3-1 is a value other than “−1” indicating no setting, the CPU 28 retrieves, from the device character string database stored in the nonvolatile memory 6, device character string data including the device type n1-1 and the device code n1-2 coinciding with the condition device type m3-1 and the condition device code m3-2 read out from the nonvolatile memory 6 and obtains the device character string data (R). The CPU 28 acquires the character string n2 “safety door opening and closing signal” from the obtained device character string data (R) and causes the display unit 5 to display the character string n2 “safety door opening and closing signal”.

When recognizing that the position of a device code displayed earlier is touched, the CPU 28 reads out, from the nonvolatile memory 6, the value “0” of the condition device type m3-1 and the value “3” of the condition device code m3-2 of the display setting information (C) designated by the storing position stored in the display setting pointer area. The CPU 28 stores “0” in the device type area, stores “3” in the device code area, and stores “1” in the condition device determination area of the memory 11.

Subsequently, the CPU 28 requests, through the controller I/F 10, the controller 3 to transmit a condition device value of the bit device #3, which is a condition device corresponding to the value “0” of the device type area and the value “3” of the device code area of the memory 11. The CPU 28 stores, in the data area of the memory 11, the condition device value of the bit device #3 received from the controller 3 through the controller I/F 10.

The CPU 28 reads out the value “0” stored in the device type area and the value “3” stored in the device code area of the memory 11. The CPU 28 retrieves, from the format database stored in the nonvolatile memory 6, format data including the device type f1-1 and the device code f1-2 coinciding with these values and obtains the format data (Z). Because a format is not stored in the format area of the memory 11, the CPU 28 stores, in the format area of the memory 11, the value “1” of the first format f2-1 within the format data (Z).

Because the value of the condition device determination area of the memory 11 is “0”, the CPU 28 reads out a condition device value of the bit device #3 from the data area of the memory 11. Because the value “1” stored in the format area of the memory 11 designates display in a binary number, the CPU 28 displays the read-out condition device value in a binary number. The display unit 5 displays the condition device value beside the condition device code.

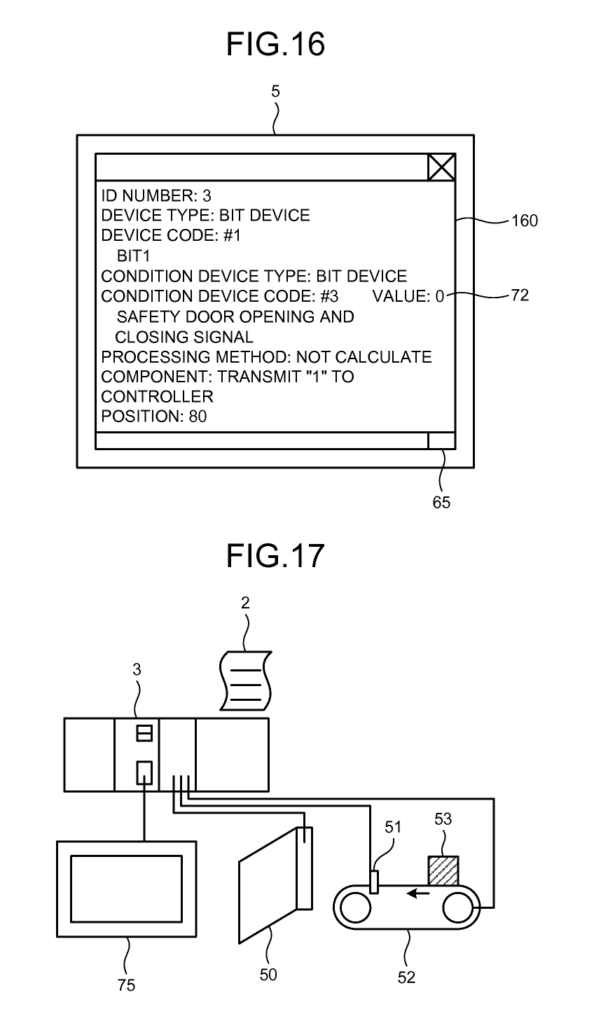

FIG. 16 is a diagram of a display example of display setting contents in the display setting information (C) and a condition device value of the bit device #3. The display unit 5 displays, together with the display setting contents 61 of the display setting information (C), a device value 72, which is a condition device value of the bit device #3 used in the display setting information (C). In this example, the device value 72 is “0”.

In the system of the production line shown in FIG. 17, when the conveyor 52 does not operate even if the user touches the position 65 on the touch panel 7, the user can recognize that the condition device value is “0” referring to the device value 72. The user can recognize that the condition device is an opening and closing signal of the safety door 50 referring to display setting content 160. Consequently, the user can easily grasp that the user should check an opening and closing state of the safety door 50. Further, when the safety door 50 is closed, the user can easily grasp that a connection state between the bit device #3 and the safety door 50 should be checked. In this embodiment, as in the embodiments explained above, it is possible to easily and quickly grasp problems such as an error in display setting information and a deficiency of a system.

The display apparatus and the operation checking method for the display apparatus according to the present invention is not limited to the application to the system of the production line explained above. The above explanation concerning the system of the production line is an example. The display apparatus and the operation checking method for the display apparatus can be applied to other systems as appropriate.

### REFERENCE SIGNS LIST

3 controller
4 memory
5 display unit
6 non-volatile memory
7 touch panel
8 mode changeover switch
9 creating apparatus I/F
10 controller I/F
11 memory
17 processed value
25 display apparatus
28 CPU
50 safety door
70 device value
126 device value change content
F1 format data
M1 display setting information
N1 device character string data
S11 selecting module
S12 retrieving module
S13 displaying module
S14 requesting module
S15 receiving module
S16 format retrieving module
S17 device value displaying module
S18 waiting module
S23 device character string displaying module
S36 input waiting module
S37 change content displaying module

1. A display apparatus comprising:
a display unit configured to display, about an external apparatus set as a control target by a controller, apparatus information concerning an operation state on a screen;
a storing unit configured to store display setting information set for the display of the apparatus information on the display unit;
a display-mode switching unit configured to switch the screen to a normal display mode for displaying the apparatus information and a display setting information display mode for displaying the display setting information;
a display-setting-information retrieving unit configured to retrieve the display setting information from the storing unit;
a display-setting-information displaying unit configured to cause the display setting information specified by the retrieval in the display-setting-information retrieving unit to be displayed on the screen, in the display setting information display mode;
a device-value requesting unit configured to request the controller to transmit a device value retained by a device, which is an area in a memory that stores the apparatus information in the controller;
a device-value receiving unit configured to receive the device value transmitted by the controller in response to the request by the device-value requesting unit; and
a device-value displaying unit configured to cause the device value received by the device-value receiving unit to be displayed on the screen, wherein
the device-value requesting unit receives input operation performed according to content of the display setting information displayed by the display-setting-information displaying unit and requests transmission of the device value.

2. The display apparatus according to claim 1, further comprising a format database configured to store format data in which a plurality of formats for defining display forms of the device value on the screen, a device type representing whether the device value is a bit or a word, and a device code affixed to the device are associated with one another, wherein
the device-value displaying unit can sequentially change a format of the device value received by the device-value receiving unit among the formats included in the format data retrieved from the format database.

3. The display apparatus according to claim 1, further comprising a processed-value displaying unit configured to calculate the device value according to a processing method included in the display setting information specified by the retrieval in the display-setting-information retrieving unit and cause the display unit to display the device value as a processed value.

4. The display apparatus according to claim 1, further comprising:
a device character string database configured to store device character string data for converting a device code affixed to the device into a character string; and
a device-character-string displaying unit configured to display, using a device code included in the display setting information specified by the retrieval in the display-setting-information retrieving unit, a character string retrieved from the device character string database.

5. The display apparatus according to claim 1, further comprising a device-value-change-content displaying unit configured to cause, about a change of the device value specified from the display setting information, designated change content to be displayed on the screen.

6. An operation checking method for a display apparatus including a display unit configured to display, about an external apparatus set as a control target by a controller, apparatus information concerning an operation state on a screen, the operation checking method comprising:
a display-mode switching step for switching the screen to a normal display mode for displaying the apparatus information and a display setting information display mode for displaying display setting information set for the display of the apparatus information on the display unit;
a display-setting-information retrieving step for retrieving the display setting information stored in advance in a storing unit included in the display apparatus;
a display-setting-information displaying step for causing the display setting information specified by the retrieval in the display-setting-information retrieving step to be displayed on the screen in the display setting information display mode;
a device-value requesting step for requesting the controller to transmit a device value retained by a device, which is an area in a memory that stores the apparatus information in the controller;
a device-value receiving step for receiving the device value transmitted by the controller in response to the request in the device-value requesting step; and
a device-value displaying step for causing the device value received in the device-value receiving step on the screen, wherein
in the device-value requesting step, on reception of an input operation performed according to the display information displayed in the display-setting-information displaying step, transmission of the device value is requested.

7. The operation checking method for the display apparatus according to claim 6, wherein
format data in which a plurality of formats for defining display forms of the device value on the screen, a device type representing whether the device value is a bit or a word, and a device code affixed to the device are associated with one another is stored in a format database, and
in the device-value displaying step, a format of the device value received in the device-value receiving step can be sequentially changed among the formats included in the format data retrieved from the format database.

8. The operation checking method for the display apparatus according to claim 6, further comprising a processed-value displaying step for calculating the device value according to a processing method included in the display setting information specified in the display-setting-information retrieving step and causing the display unit to display the device value as a processed value.

9. The operation checking method for the display apparatus according to claim 6, wherein
device character string data for converting a device code affixed to the device into a character string is stored in a device character string database, and
the operation checking method further comprising a device-character-string displaying step for displaying, using a device code included in the display setting information specified in the display-setting-information retrieving step, a character string retrieved from the device character string database.

10. The operation checking method for the display apparatus according to claim 6, further comprising a device-value-change-content displaying step for displaying change content designated when a device value included in the display setting information specified in the display-setting-information retrieving step is changed.
